(19) United States
(12) Patent Application Publication
(10) Pub. No.: US 2009/0307500 A1
(43) Pub. Date: Dec. 10, 2009

(54) PROGRAM OBFUSCATOR

(76) Inventors: Taichi Sato, Osaka (JP); Rieko Asai, Osaka (JP); Kenneth Alexander Nicolson, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/162,706

(22) PCT Filed: Feb. 6, 2007
(86) PCT No.: PCT/JP2007/052026

§ 371 Date: Nov. 18, 2008

(30) Foreign Application Priority Data
Feb. 6, 2006 (JP) 2006-028579

(51) Int. Cl. G06F 21/22

(52) U.S. Cl. 713/190

(57) ABSTRACT

A program obfuscator of the present invention divides a target program into a plurality of blocks and determines program instructions allocated according to an input/output relation between the blocks, in order to diffuse and allocate the program instructions for calculating a value of secret information in various places of the program. More specifically, with regard to a variable for calculating the secret information transferred to and from the blocks, a value of the variable when outputted from a block is equalized to a value of the variable when inputted to a next block. A random variable conversion instruction is added to each of the blocks so that a value of the variable when outputted from each block is in a range of a value expected as an input to the next block.

### TECHNICAL FIELD

The present invention relates to software protection, especially to program obfuscation.

### BACKGROUND ART

The software protection means protecting software from being tampered, analyzed, copied, or the like, i.e. keeping confidentiality of the software.

For example, there is a technique of encrypting a video content or the like for preventing the video content from being copied. An encryption program performs encryption/decryption processing using an encryption key that is secret information. Therefore, if an unauthorized analyst analyzes the encryption algorithm and deprives the encryption key, the unauthorized analyst can decrypt the encrypted video content and use the content freely.

Also, there is a technique of digital watermarking for controlling copying by embedding a watermark in an image. However, if an unauthorized analyst analyzes processing and an algorithm of a program of detecting such a watermark, there is a risk that the unauthorized analyst may create a tool of removing the embedded watermark from the image based on a result of the analysis. That is to say, copying of image data gets out of control, resulting in anyone freely copying an original image.

As mentioned above, if confidentiality of software cannot be kept, many disadvantages are caused such that a right of a software holder is not protected and a serious commercial loss is caused. In order to avoid such disadvantages, a technique of making it difficult to analyze a program has been requested.

In response to the request, for example, a non-patent document 1 discloses the following method. The method makes it difficult to analyze a program by (i) converting an original program including secret information to a new program in which the secret information can be calculated by executing a plurality of program instructions and (ii) further diffusing the program instructions in various places of the new program.

If a program code is complicated, i.e. the program is obfuscated, it takes a long time to analyze the program. As a result, secret information included in the program can be prevented from being analyzed.

Non-patent document 1: Kamoshida, Matsumoto, Inoue “On Constructing Tamper Resistant Software”, ISEC97-59

### DISCLOSURE OF THE INVENTION

### Problems the Invention is Going to Solve

However, there may be a case where it is difficult to complicate a program having a predetermined control structure by such a method of the program obfuscation.

The predetermined control structure is a complicated control structure including many branches and loops. In a program having such a complicated control structure, there are a plurality of routes to a place for using secret information. Also, in the complicated program, there is a restriction that a calculation result that is the secret information must be same even if any of the routes is taken when the program is executed.

In other words, the program instructions of calculating the secret information must be allocated to routes that are necessarily taken when the program is executed.

In this case, if an unauthorized analyst focuses the analysis on a place such as an entry of a program that does not include a branch, the unauthorized analyst can relatively easily obtain the secret information.

In view of the above problem, an object of the present invention is to provide a program obfuscator for generating a program in which complicated program instructions are extensively diffused and allocated, even if the program has a complicated control structure.

### Means of Solving the Problems

The above-mentioned object can be achieved by a program obfuscator for generating an obfuscated program from a target program composed of a plurality of blocks, wherein each of the blocks is composed of a sequence of instructions, execution control for the block is (a) transferred from a previously executed block only to a first instruction of the block, and (b) transferred only from a last instruction of the block to a next executed block, and the program obfuscator comprises: an attribute determining unit operable to determine an attribute for an entry and an attribute for an exit of each of one or more of the blocks so that an exit attribute of one of the blocks is same as an entry attribute of a next block to which the execution control is transferred from the one of the blocks; and a generating unit operable to generate the obfuscated program by adding one or more instructions to the one or more of the blocks, the one or more instructions being created according to the entry attribute or the exit attribute of each of the one or more of the blocks.

Note that the execution control means control of selecting routes that can be performed when the program is executed.

### EFFECTS OF THE INVENTION

In the program obfuscator of the present invention with the above-stated construction, a same attribute is set as each of an exit attribute of a transfer source block and an entry attribute of a transfer destination block to which the execution control is transferred from the transfer source block. As a result, it is assured that the processing passed from the transfer source block to the transfer destination block is the processing expected by the transfer destination block.

Therefore, the transfer destination block can perform the processing according to the expected processing.

Also, the target program includes secret information, the program obfuscator further comprises: a block specifying unit operable to specify one of the blocks as a secret block, the specified block including an instruction to obtain the secret information using one or more values of one or more specific variable, each attribute is associated with the one or more specific variables and the one or more values to be taken by each of the specific variables, and the generating unit generates the obfuscated program by adding one or more instructions to each block from which the execution control is transferred to the secret block, the one or more instructions causing the specific variable to take one of the values associating with exit attribute of the block.

With the above-stated construction, a same attribute is set as each of an exit attribute of a transfer source block and an entry attribute of a transfer destination block to which the execution control is transferred from the transfer source block. As a result, it is assured that a value of a specific variable passed from the transfer source block to the transfer destination block is a value expected by the transfer destination block. This is because the specific variable is determined according to an attribute.

Therefore, even if any program instruction using the specific variable is added in a transfer source block from which the execution is transferred to the secret block, the secret information can be obtained using the specific variable in the secret block if the specific variable indicates a value according to an exit attribute at an exit of the transfer source block.

That is to say, because the secret information is obtained from the specific variable, the secret information does not directly appear in the program and an expression of obtaining the secret information is away from a location of the secret information. Therefore, it becomes difficult to find the location of the secret information, resulting in an increase of the possibility that the secret information can be prevented from being stolen.

Moreover, when the execution control is transferred to the secret block from two or more of the blocks, the generating unit generates the obfuscated program by adding one or more instructions to each of the two or more of the blocks, the one or more instructions causing the specific variable to take one of the values associating with an exit attribute of each of the two or more of the blocks.

With the above-stated construction, even if any route is taken when the program is executed, the specific variable indicates an expected value at an entry of the secret block. Therefore, the secret information can be obtained using the specific variable in the secret block.

Furthermore, the generating unit generates the obfuscated program by adding one or more instructions to each block to be executed before the secret block, the one or more instructions causing the specific variable to change from one of the values associating with an entry attribute of the block to one of the values associating with an exit attribute of the block.

With the above-stated construction, the blocks that can be continuously executed share the attributes thereof and perform a conversion according to the attributes. Therefore, the program instructions for obfuscation can be added to all of the blocks.

That is to say, even if any program instruction using the specific variable is added to all of the blocks, processing of canceling the conversion according to an entry attribute can be added to each of the blocks, so that the specific variable indicates a value according to an exit attribute at each exit of the blocks. As a result, it can be assured that a processing result before the obfuscation and a processing result after the obfuscation are same.

In other words, even in a program having a complicated control structure, program instructions can be added to all of the blocks and it can make it difficult to analyze the program.

That is to say, this can complicate the processing for the complicated control structured program, which was difficult by the conventional technology.

In the present invention, at least in a case where the program is executed without forcibly changing an execution procedure of the program using a debugger (hereinafter, referred to as “when the program is executed in a normal system”), a function can be added to a block. The function is canceling a change added to the block before the execution control is transferred to the block. Because blocks to and from which the execution control is transferred share the attributes, it is certain that a change according to an entry attribute is added to the blocks.

Therefore, at least when the program is executed in the normal system, it is assured that an execution result of the program does not vary in the blocks. Therefore, the obfuscation by the added program instruction can be performed in various places in the program, regardless of a control structure of the program.

When taking a loop as an example, an influence of the processing added by the obfuscation is canceled in the loop regardless of how many times the execution control circulates in the loop. Therefore, a result outputted from the loop is equal to a result before the obfuscation. That is to say, the output result of the program does not vary before and after the obfuscation.

In the conventional technology, a location for complicating the processing is limited in order to equalize output results of a program before and after obfuscation. On the other hand, the processing can be complicated without such a limitation in the present invention.

Also, the program obfuscator further comprises: a variable adding unit operable to add, to the target program, a variable that is not included in the target program, wherein the specific variable is the variable added by the variable adding unit.

With the above-stated construction, a program after the obfuscation can be generated using a variable that is not used in a program before the obfuscation. Therefore, the obfuscation can be performed without affecting an original execution of the program and the secret information can be protected.

Moreover, at least one of an entry attribute and an exit attribute of each of the blocks is associated with a plurality of values to be taken by the specific variable, and the generating unit generates the obfuscated program by adding one or more instructions to one of the blocks, the one or more instructions changing the specific variable from one of the plurality of values associating with an entry attribute of the block to one of the plurality of values associating with an exit attribute of the block.

With the above-stated construction, the number of values of the specific variables at an entry of a block is not one. Therefore, this makes it more difficult to analyze the program being executed using a debugger or the like.

Furthermore, at least one of an entry attribute and an exit attribute of each of the blocks is associated with a plurality of specific variables, and the generating unit generates the obfuscated program by (i) adding an instruction to the one of the blocks to replace a value of one of the specific variables with a value of another specific variable according to the exit attribute of the one of the blocks and (ii) adding an instruction to the next block to replace the value of the specific variable with the value of the another specific variable according to the entry attribute of the next block.

With the above-stated construction, a role of the specific variable differs for each of the blocks. Therefore, this makes it more difficult to analyze the program.

Also, each attribute is associated with a predetermined operation, and the generating unit generates the obfuscated program by (i) performing a predetermined operation associating with the exit attribute of the one of the blocks on a value of the specific variable to obtain a first result value, and adding an instruction to the one of the blocks to assign the first result value to a value of the specific variable and (ii) performing an inverse operation of the predetermined operation on the value of the specific variable to obtain a second result value, the inverse operation associating with the entry attribute of the next block, and adding an instruction to the next block to assign the second result value to the value of the specific variable.

With the above-stated construction, a value of the specific variable differs for each of the blocks. Therefore, this makes it more difficult to analyze the program.

Moreover, the program obfuscator further comprising: an encrypting unit operable to encrypt the blocks, wherein each attribute is associated with an encryption key, and the generating unit generates the obfuscated program by (i) adding one or more instructions to the one of the blocks, the one or more instructions performing processing of decrypting the next block using an encryption key associating with the exit attribute of the one of the blocks and (ii) causing the encrypting unit to encrypt the one of the blocks using an encryption key associating with an entry attribute of the one of the blocks.

With the above-stated construction, the blocks can be encrypted using the keys that differ for each of the blocks. Therefore, this makes it more difficult to analyze the program.

The above-mentioned object can be also achieved by a program obfuscator for generating an obfuscated program from a target program composed of a plurality of blocks, wherein each of the blocks is composed of a sequence of instructions, and the program obfuscator comprises: an attribute determining unit operable to determine an attribute for an entry and an attribute for an exit of each of one or more of the blocks so that an exit attribute of one of the blocks is same as an entry attribute of a next block to which execution control is transferred from the one of the blocks; and a generating unit operable to generate the obfuscated program by adding one or more instructions to an execution route of each of one or more of the blocks, the one or more instructions being created according to the entry attribute or the exit attribute of each of the one or more of the blocks, and the execution control passing through the execution route from each entry.

With the above-stated construction, the obfuscation can be performed even if a size of the block becomes larger. Therefore, a processing speed required for the obfuscation can be increased.

The above-mentioned object can be also achieved by a program obfuscator for generating an obfuscated program from a target program composed of a plurality of blocks, wherein each of the blocks is composed of a sequence of instructions, execution control for the block is (a) transferred from a previously executed block only to a first instruction of the block, and (b) transferred only from a last instruction of the block to a next executed block, and the program obfuscator comprises: an attribute determining unit operable to determine an attribute for an entry and an attribute for an exit of each of the blocks; and a generating unit operable to generate the obfuscated program by adding one or more instructions to one or more of the blocks, the one or more instructions being created according to the entry attribute or the exit attribute of each of the one or more of the blocks, wherein each attribute is associated with one or more specific variables and one or more values to be taken by each of the specific variables, an entry attribute of each block to which the execution control is transferred from two or more of the blocks is associated with a value associating with an exit attribute of each of two or more of the blocks, and the generating unit generates the obfuscated program by adding one or more instructions to one or more of the blocks, the one or more instructions changing the specific variable from one of the one or more values associating with an entry attribute of each of the one or more of the blocks to one of the one or more values associating with an exit attribute of each of the one or more of the blocks.

With the above-stated construction, when the execution control is transferred to one block from a plurality of blocks, it is not required that exit attributes of the blocks from which the execution control is transferred are same. As a result, values of the specific variables at exits of the blocks are different, and this makes it more difficult to analyze the program.

### BRIEF DESCRIPTION OF THE DRAWINGS

FIG. 1 shows an example of a computing system of a program obfuscator of the present invention.

FIG. 2 is a block diagram showing a structure example of a program obfuscator 1000.

FIG. 3 shows an example of a target program 2000 for obfuscation.

FIG. 4 shows an example of an obfuscated program 3000 obtained as a result of obfuscating the target program.

FIG. 5 is a flowchart showing obfuscation processing performed by the program obfuscator 1000.

FIG. 6 shows a target program 2100 to which additional variables are added.

FIG. 7 shows blocks B1 to B5 each of which is a basic block generated by a program dividing unit 1200 based on the target program 2100.

FIG. 8 shows a control flow of the target program 2100.

FIG. 9 shows a generation process of an attribute information allocation table 1800 generated by an attribute information allocation table generating unit 1320, and examples of a structure and the content of the attribute information allocation table 1800.

FIG. 10 is a flowchart showing attribute information allocation table generation processing.

FIG. 11 is a control flow showing attributes set to entries and exits of the blocks.

FIG. 12 shows examples of a structure and the content of a mapping correspondence table 1900.

FIG. 13 shows converted blocks generated by a block converting unit 1400 by converting the blocks B1 to B5.

FIG. 14 shows the obfuscated program 3000 including a converted secret block.

FIG. 15 shows examples of a structure and the content of a mapping correspondence table 4900 of a second embodiment.

FIG. 16 is a block diagram showing a structure example of a program obfuscator 4000 of the second embodiment.

FIG. 17 shows a converted block B2 generated by a block converting unit 4400 by converting the block B2.

FIG. 18 shows conversions at an entry and an exit of the block B2.

FIG. 19 shows a replacement by a program instruction group G_2_4.

FIG. 20 shows examples of a structure and the content of a mapping correspondence table 5900 of a third embodiment.

FIG. 21 is a block diagram showing a structure example of a program obfuscator 5000 of the third embodiment.

FIG. 22 shows a converted block B2 generated by a block converting unit 5400 by converting the block B2.

FIG. 23 shows examples of a structure and the content of a mapping correspondence table 6900 of a fourth embodiment.

FIG. 24 is a block diagram showing a structure example of a program obfuscator 6000 of the fourth embodiment.

FIG. 25 shows a converted block in the fourth embodiment.

FIG. 26 is a flowchart showing processing performed by a block converting unit.

FIG. 27 is a conceptual diagram showing an example of a conventional obfuscation method.

FIG. 28 shows an original program 9100 before obfuscation.

FIG. 29 shows a control flow of the original program 9100.

FIG. 30 shows a control flow of an obfuscated program to which program instructions for calculating secret information are allocated.

FIG. 31 shows a control flow of an obfuscated program in which program instructions for calculating secret information are diffused.

### DESCRIPTION OF REFERENCE NUMERALS

10 computing system
1000 4000 5000 program obfuscator
1100 variable adding unit
1200 program dividing unit
1300 mapping information generating unit
1310 control flow generating unit
1320 attribute information allocation table generating unit
1330 mapping correspondence table generating unit
1400 block converting unit
1500 secret block converting unit
1800 attribute information allocation table
1900 4900 5900 6900 mapping correspondence table
2000 2100 target program
3000 obfuscated program
9100 original program

### BEST MODE FOR CARRYING OUT THE INVENTION

### First Embodiment

### Outline

The program obfuscator of the present invention can generate a program in which complicated program instructions are allocated to all routes to a place in which secret information is used, even if the program has a complicated control structure including many branches and loops.

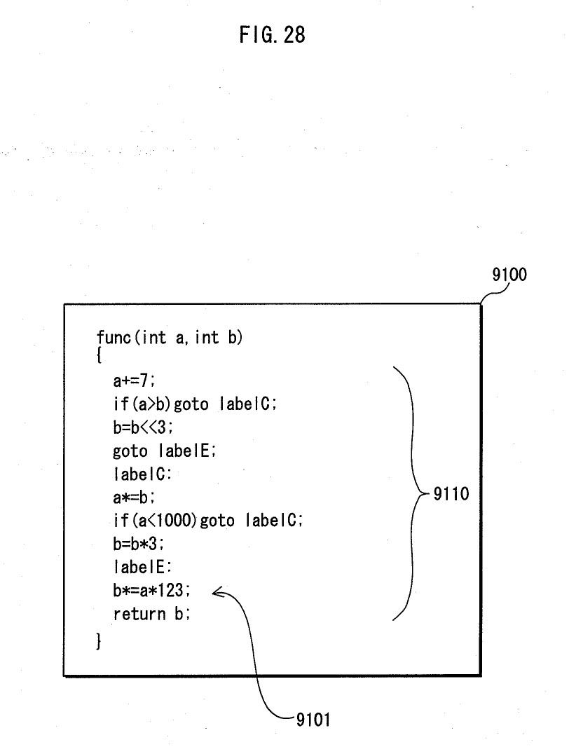

Before an explanation of the present invention, conventional program obfuscation will be simply described with reference to FIGS. 28 to 31. A method and a problem of the conventional program obfuscation will be specifically described later.

### <Conventional Program Obfuscation>

FIG. 28 shows an original program 9100 before obfuscation. The original program 9100 is composed of a program instruction group 9110. Here, secret information is “123” in a program instruction 9101.

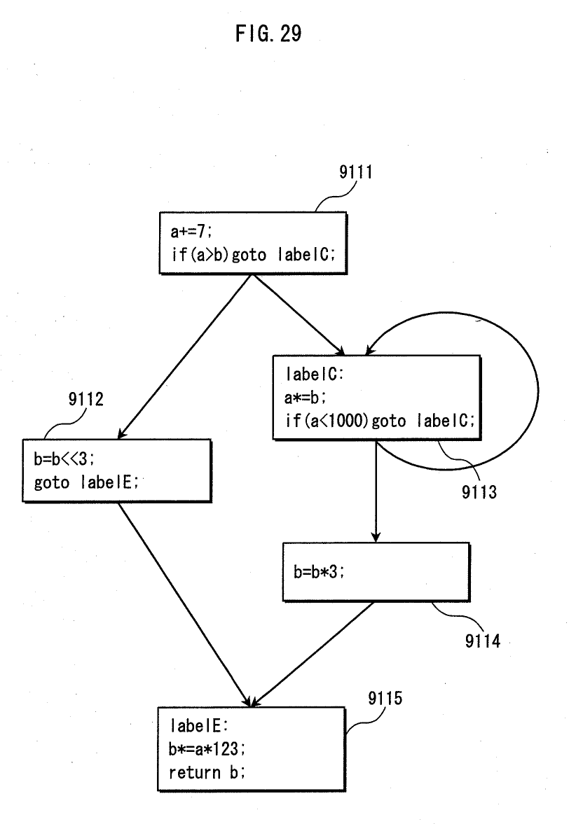

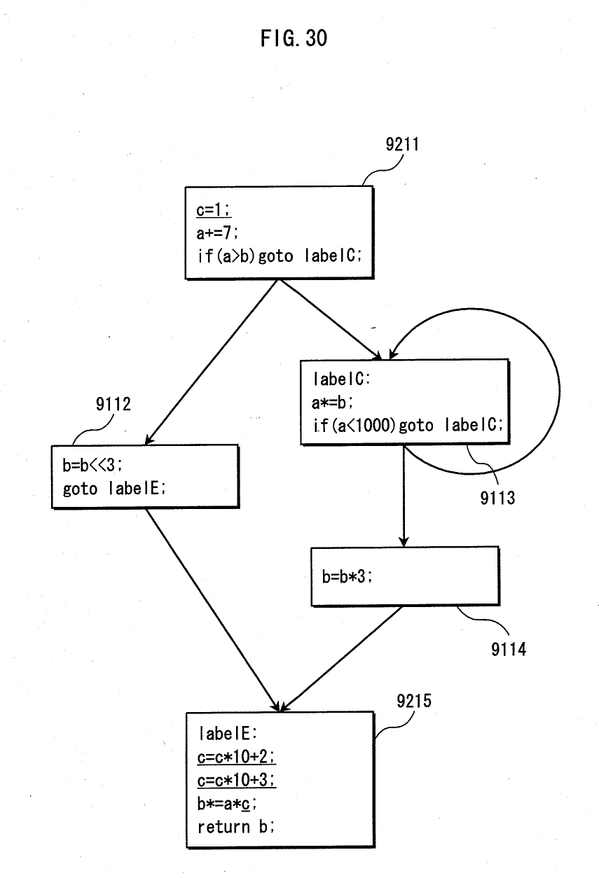

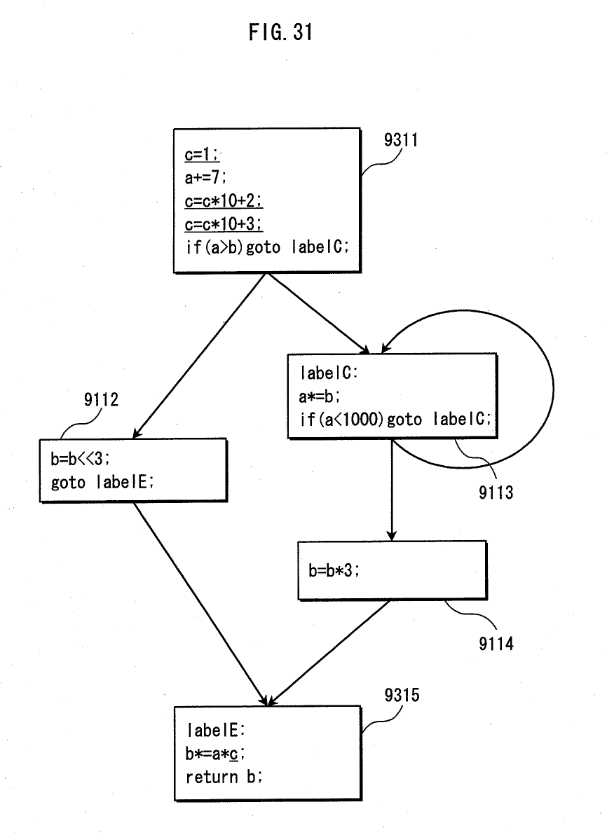

FIG. 29 shows a control flow of the original program 9100 composed of blocks 9111 to 9115. Also, each of FIGS. 30 and 31 shows a control flow of an obfuscated program to which program instructions for calculating the secret information are allocated. The control flow shown in FIG. 30 is composed of blocks 9211 to 9215, and the control flow shown in FIG. 31 is composed of blocks 9311 to 9315.

In FIG. 30, an obfuscated program is generated by adding a new variable “c” to the original program 9100 (refer to an underlined part in the block 9211), adding program instructions for calculating the secret information “123” using the added variable “c”, and replacing the secret information “123” with “c” (refer to underlined parts in the block 9215).

FIG. 31 shows a program in which the program instructions added in FIG. 30 are diffused in various places in the program.

Here, these program instructions cannot move to one side of a conditional branch and cannot be included in a loop. This is because a value of “c” with which the secret information “123” is replaced indicates a value different from “123”.

Therefore, in this program example, the program instructions move to the block 9311 in order to assure that the value of “c” finally indicates “123”.

As mentioned above, in the conventional method, the program including many branches and loops does not have many places to which the program instructions can move. As a result, the program instructions cannot be fully diffused and are concentrated in a specific place, i.e. a place other than places in which it is difficult to diffuse the program instructions (such as a place which is not affected by the branches and loops). Therefore, an unauthorized analyst can relatively easily find a program instruction group for calculating the secret information by intensively analyzing the specific place.

The program obfuscator of the present invention can allocate program instructions to a place that is conventionally considered difficult that the program instructions are diffused therein.

The following describes the program obfuscator of a first embodiment of the present invention.

The first embodiment explains an example of obfuscation by converting a program so that secret information is calculated by executing a plurality of program instructions. In the obfuscation, a program after obfuscation (hereinafter, referred to as “obfuscated program”) is generated by adding a new variable to a program before the obfuscation (hereinafter, referred to as “target program”), replacing the secret information with an expression for calculating the secret information using the variable, and extensively allocating other expressions to the replaced expression for calculating the secret information using the variable in the program before the obfuscation.

### <Structure>

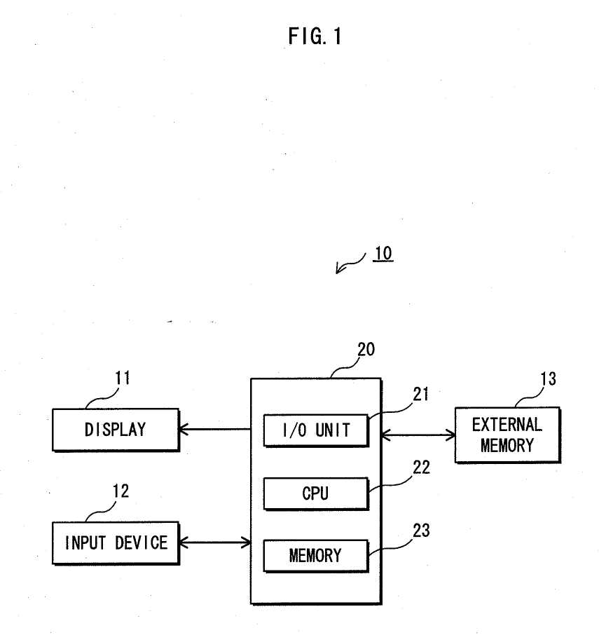

FIG. 1 shows an example of a computing system of the program obfuscator of the present invention.

A computing system 10 includes a general-purpose computer 20, a display 11 for displaying a program or the like, an input device 12 for performing processing when receiving a user's instruction via a keyboard or the like, and an external memory 13 for storing therein the program. The computer 20 includes an I/O unit 21 for managing input and output, a CPU (Central Processing Unit) 22 for performing an operation, and a memory 23. Also, the computer 20 has an ordinary function of a computer.

An obfuscated program for performing the program obfuscation of the present invention is stored in the memory 23 and the external memory 13. Then, the obfuscated program is executed by the CPU 22 to realize the obfuscation processing. A target program is timely read from the external memory 13 via the I/O unit 21 and is obfuscated. The obfuscated program is outputted to the external memory 13 via the I/O unit 21.

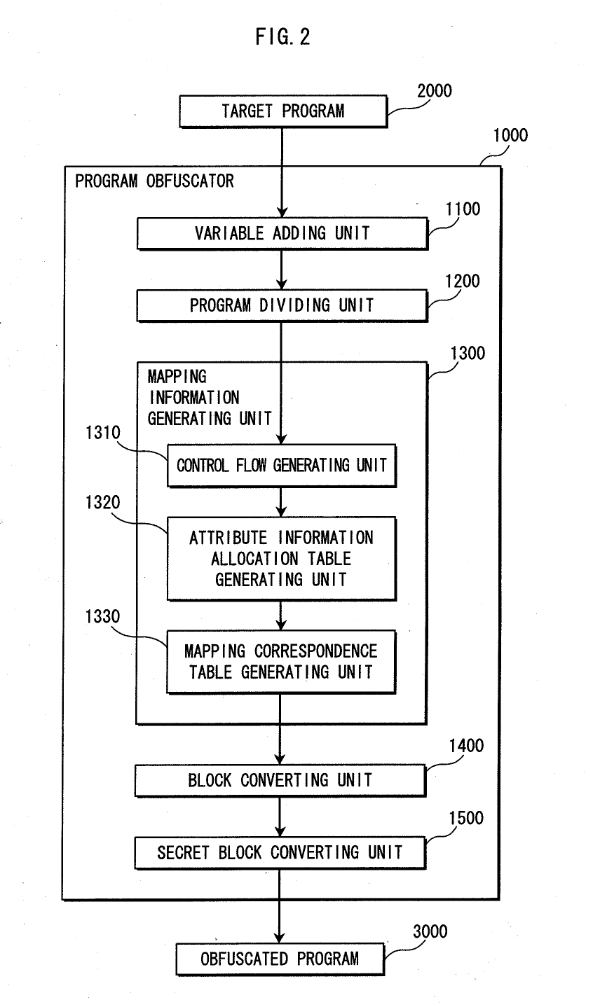

The following describes a structure of a program obfuscator 1000 of the present invention, with reference to FIG. 2.

FIG. 2 is a block diagram showing a structure example of the program obfuscator 1000. The program obfuscator 1000 includes a variable adding unit 1100, a program dividing unit 1200, a mapping information generating unit 1300, a block converting unit 1400, and a secret block converting unit 1500. Also, the program obfuscator 1000 includes an input unit (not shown) for reading a target program 2000 from outside and an output unit (not shown) for outputting an obfuscated program 3000.

The target program 2000 is read by the input unit and sequentially processed by the variable adding unit 1100, the program dividing unit 1200, the mapping information generating unit 1300, the block converting unit 1400, and the secret block converting unit 1500. Then, the obfuscated program 3000 obtained as a result of the above processing is outputted by the output unit.

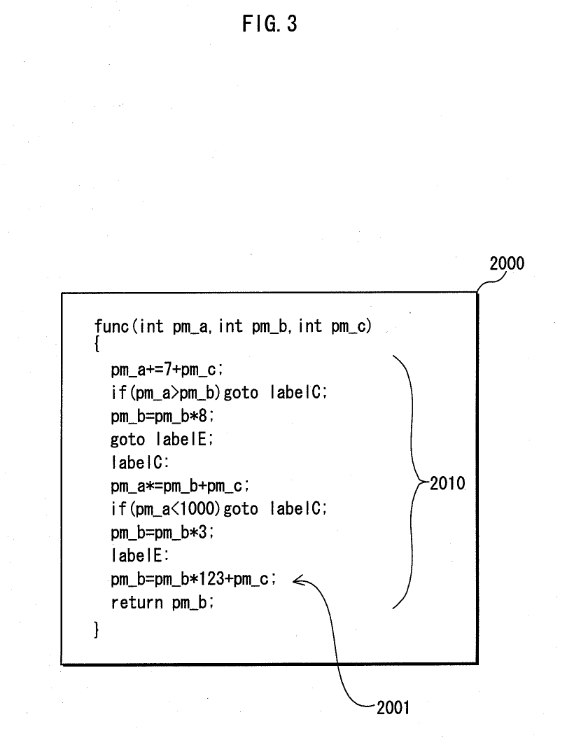

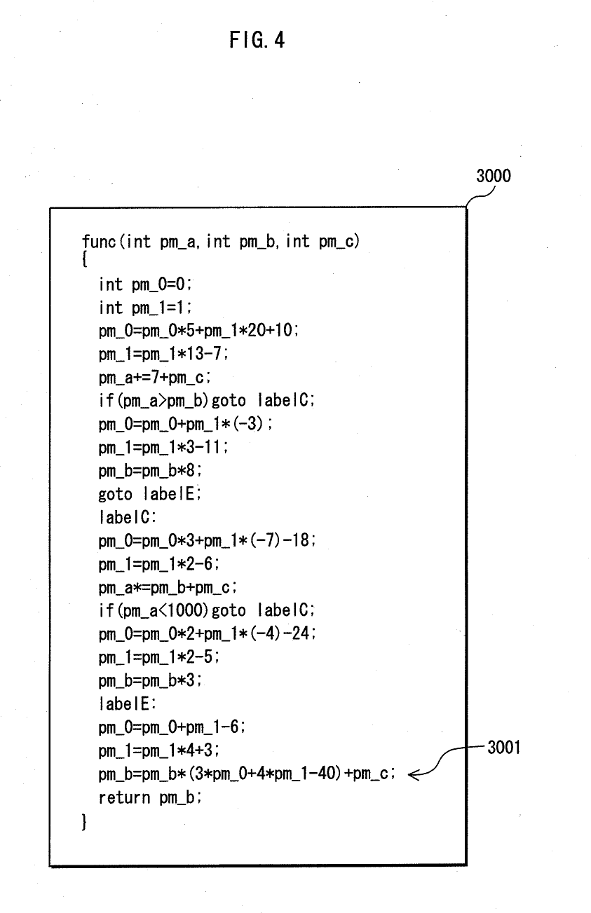

FIG. 3 shows an example of the target program 2000 for obfuscation, and FIG. 4 shows an example of the obfuscated program 3000 obtained after the target program 2000 is obfuscated.

The following simply describes each of the functional units. Then, each of the functional units will be specifically described using concrete examples, with reference to FIGS. 3 to 13.

The variable adding unit 1100 adds a new variable which is not used in the target program 2000 (hereinafter, referred to as “additional variable”) to the target program 2000.

The program dividing unit 1200 divides the target program into a plurality of blocks each composed of one or more program instructions.

The mapping information generating unit 1300 generates a mapping for causing the additional variable to correspond to a certain value, and includes a control flow generating unit 1310, an attribute information allocation table generating unit 1320, and a mapping correspondence table generating unit 1330.

The control flow generating unit 1310 generates a control flow of the target program. The attribute information allocation table generating unit 1320 allocates an attribute to each of an entry and an exit of a block by referring to the control flow and generates an attribute information allocation table.

The mapping correspondence table generating unit 1330 determines a mapping for each of attributes in the attribute information allocation table, and generates a mapping correspondence table.

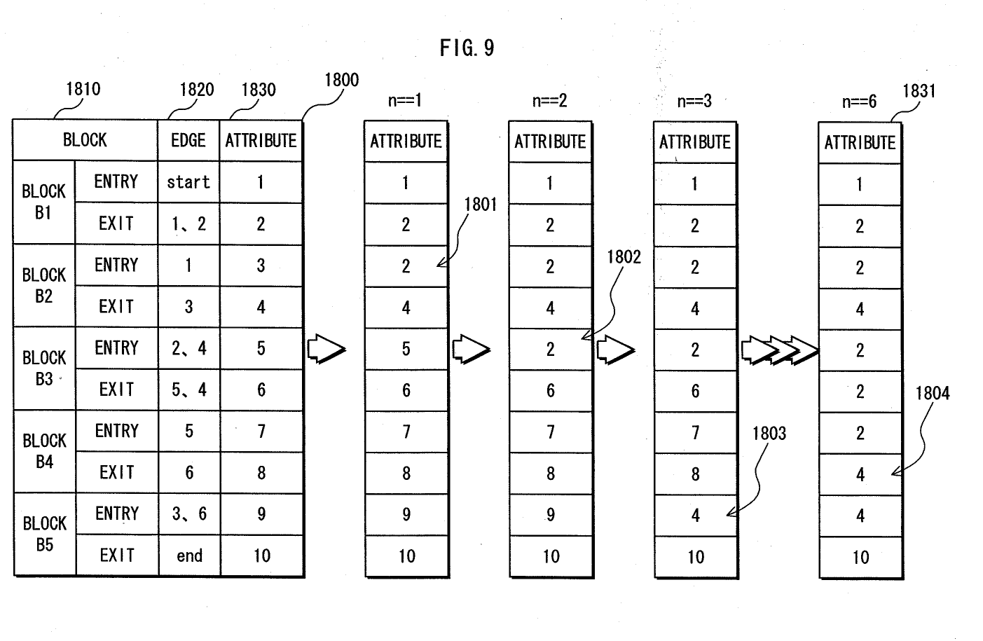

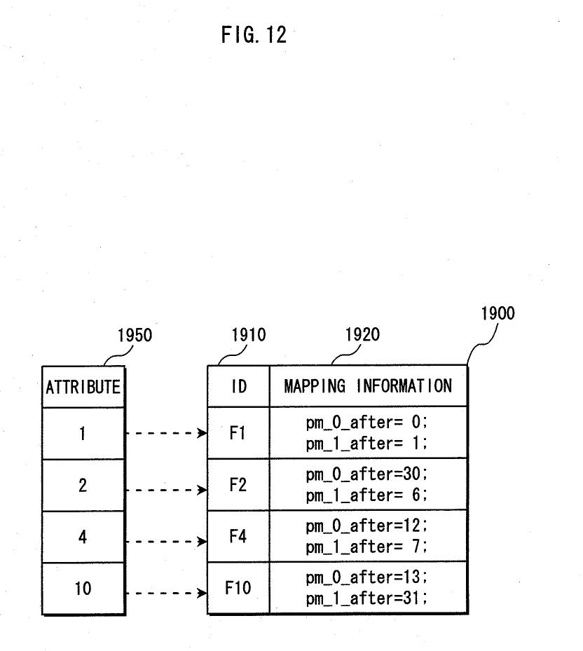

Note that the attribute information allocation table and the mapping correspondence table will be described later, with reference to FIGS. 9 and 12.

The block converting unit 1400 adds a program instruction for converting a value of the additional variable to each block, based on the mapping generated by the mapping information generating unit 1300.

The secret block converting unit 1500 adds a program instruction for calculating secret information using the additional variable to a block including the secret information (hereinafter, referred to as “secret block”).

### <Operation>

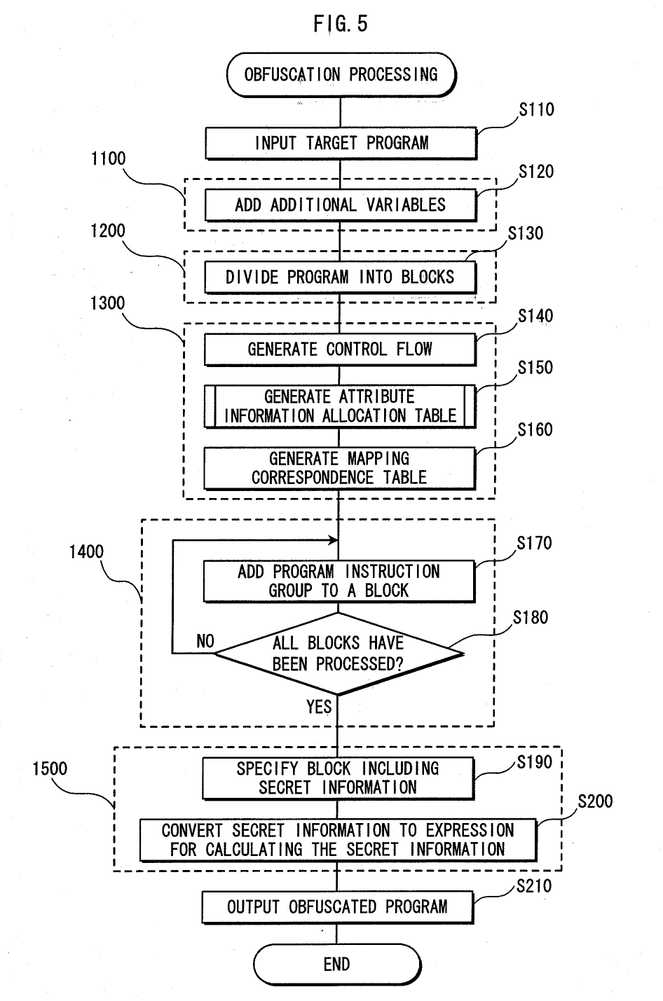

FIG. 5 is a flowchart showing obfuscation processing performed by the program obfuscator 1000. The following describes processing of generating the obfuscated program 3000 from the target program 2000, with reference to FIG. 5. In addition, a function of each of the functional units will be also specifically described. Note that a rectangle surrounded by a dotted line in FIG. 5 indicates each of the functional units performing processing shown in the rectangle.

The target program 2000 includes a function func. The function func performs processing of a program instruction group 2010 using variables pm_a, pm_b, and pm_c as inputs, and outputs the variable pm_b. Note that “123” in a program instruction 2001 is secret information (refer to FIG. 3).

The obfuscated program 3000 is obtained by adding a plurality of program instructions to the target program 2000. In a program instruction 3001, the secret information “123” is converted to an expression “3*pm_{—}0+4*pm_{—}1−40” (refer to FIG. 4).

The following describes the obfuscation processing based on the flowchart in FIG. 5.

Firstly, the input unit reads the target program 2000 in a working memory in the input unit (step S110).

### <Processing by the Variable Adding Unit 1100>

Next, the variable adding unit 1100 adds variables to the read target program 2000 (step S120).

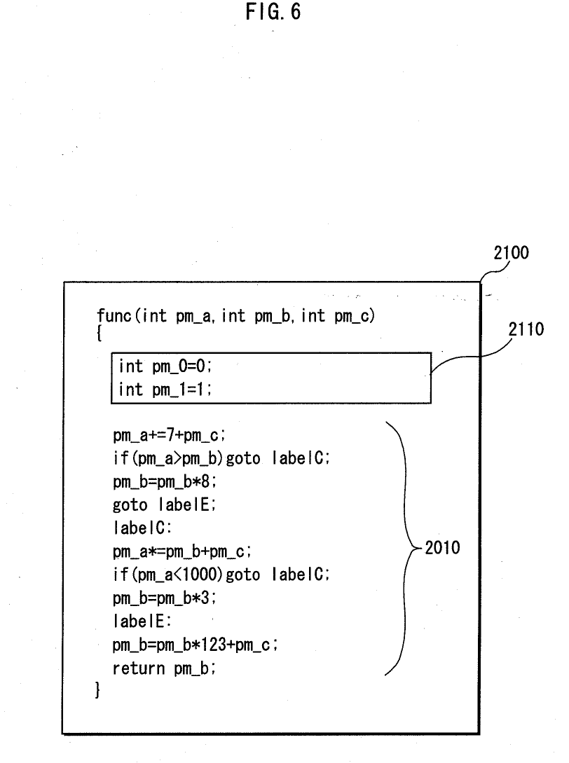

FIG. 6 shows a target program 2100 to which the additional variables are added.

In the first embodiment, two variables “pm_{—}0” and “pm_{—}1” are added to the target program 2100.

The variable adding unit 1100 randomly determines an initial value of each of the additional variables “pm_{—}0” and “pm_{—}1”. Here, the variable adding unit 1100 determines the initial values of the additional variables “pm_{—}0” and “pm_{—}1” as “0” and “1” respectively. Then, the variable adding unit 1100 adds a variable declaration of the additional variables “pm_{—}0” and “pm_{—}1” to the target program 2000.

A variable declaration part 2110 is the variable declaration of the additional variables “pm_{—}0” and “pm_{—}1” added to the target program 2000.

Note that the number of added variables, names of the added variables, and types of the added variables may be fixed, may be inputted by a user via the input device 12, and may be randomly determined. Also, the additional variables may be an array.

Also, the first embodiment explains a case of C language that is a programming language requiring the variable declaration. However, a method of defining an additional variable or the like is according to the programming language (the same is applied to the following explanations). For example, in a language that does not require the variable declaration such as BASIC, only a setting of an initial value may be written.

### <Processing by the Program Dividing Unit 1200>

The variable adding unit 1100 transmits the target program 2100 to which the additional variables are added to the program dividing unit 1200. The program dividing unit 1200 divides the program instruction group 2010 in the target program 2100 into a plurality of basic blocks (step S130).

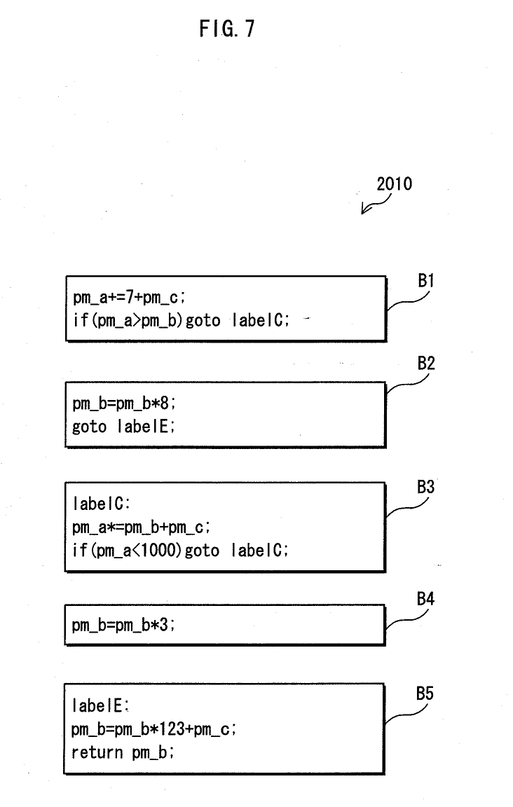

FIG. 7 shows blocks B1 to B5 that are the basic blocks generated by the program dividing unit 1200 from the target program 2100.

Here, each of the basic blocks is a program instruction group composed of one or more program instructions. An execution route meets only at a beginning of the program instruction group, and branches only at an end of the program instruction group.

More specifically, when generating a basic block, any one of the following three program instructions is defined as a starting program instruction of the basic block. The first program instruction is a program instruction at an entry of a program (a program instruction initially executed in the program). The second program instruction is a program instruction at which the execution route meets, such as Label sentence. The third program instruction is a program instruction next to a branch instruction such as a goto sentence.

Then, anyone of the following three program instructions is determined as an ending program instruction. The first program instruction is a program instruction immediately before a program instruction at which the execution route meets next to the starting program instruction. The second program instruction is a program instruction at an exit of the program (a program instruction lastly executed in the program). The third program instruction is a branch instruction.

A program instruction group composed of program instructions from the starting program instruction to the ending program instruction is defined as the basic block.

All of the program instructions composing the target program 2100 are divided by a basic block generation step so as to be included in any one of the basic blocks (refer to FIG. 7). Note that the target program and the blocks can be referred by other functional units if required.

### <Processing by the Mapping Information Generating Unit 1300>

The program dividing unit 1200 transmits the generated blocks to the mapping information generating unit 1300, and the mapping information generating unit 1300 generates mapping information to be set to an entry and an exit of each of the blocks. The above processing is performed by the control flow generating unit 1310, the attribute information allocation table generating unit 1320, and the mapping correspondence table generating unit 1330 each composing the mapping information generating unit 1300.

The following describes the mapping information to be set to an entry and an exit of each of the blocks.

The mapping information at the entry (hereinafter, referred to as “entry mapping information”) and the mapping information at the exit (hereinafter, referred to as “exit mapping information”) are used when a block is converted by the block converting unit 1400 and the secret block converting unit 1500.

The mapping information indicates the following mapping. When a set of elements that are values to be taken by pm_X (X=0, 1) is defined as a set PM_X, the mapping causes (pm_{—}0 before, pm_{—}1 before) satisfying pm_{—}0 beforeεPM_{—}0, pm_{—}1_beforeεPM_{—}1 to correspond to (pm_{—}0_after, pm_{—}1_after) satisfying pm_{—}0_afterεPM_{—}0, pm_{—}1_afterεPM_{—}1. Also, the image by the mapping (pm_{—}0_after, pm_{—}1_after) is one point (for example, (0, 1)).

For example, mapping information “pm_{—}0_after=0; pm_{—}1_after=1;” indicates a mapping for causing all (pm_{—}0_before, pm_{—}1_before) satisfying pm_{—}0_beforeεPM_{—}0, pm_{—}1_beforeεPM_{—}1 to correspond to the point (0, 1). More specifically, this mapping indicates that the values of the additional variables pm_{—}0, pm_{—}1 are converted to the point (0, 1) that are values of (pm_{—}0_after, pm_{—}1_after).

### <Processing by the Control Flow Generating Unit 1310>

The program dividing unit 1200 transmits the basic blocks generated by dividing the target program 2000 to the control flow generating unit 1310 via the mapping information generating unit 1300. Then, the control flow generating unit 1310 generates a control flow (step S140).

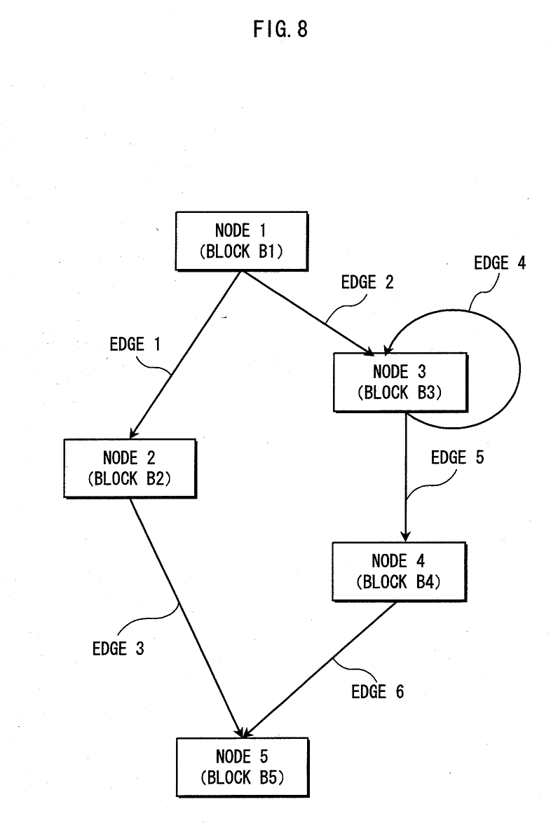

FIG. 8 shows the control flow of the target program 2100.

The control flow is a graph composed of nodes and edges. In FIG. 8, nodes 1 to 5 indicate the nodes composing the control flow, and edges 1 to 6 indicate the edges composing the control flow.

The control flow generating unit 1310 generates the control flow shown in FIG. 8 from the basic blocks of the target program 2100 (refer to FIG. 7) by the following method.

Firstly, the control flow generating unit 1310 generates the nodes 1 to 5 corresponding to the blocks B1 to B5 included in the target program 2100.

Then, when there is a branch between a first block and a second block, the control flow generating unit 1310 provides an edge from a node corresponding to the first block to a node corresponding to the second block.

In the block B1, for example, when a conditional expression “pm_a>pm_b” in a program instruction “if(pm_a>pm_b) goto label C;” is false (refer to FIG. 7), the execution route branches to the block B2. On the other hand, the conditional expression is true, the execution route branches to the block B3 corresponding to “label C;”.

Therefore, the control flow generating unit 1310 provides an edge 1 between the node 1 corresponding to the block B1 and the node 2 corresponding to the block B2, and an edge 2 between the node 1 corresponding to the block B1 and the node 3 corresponding to the block B3.

In the same manner as this, the control flow generating unit 1310 provides edges 3 to 6.

Note that in this description of the present invention, all moves of the execution control between blocks are referred to as “branch” regardless of whether or not the number of branch destinations is plural.

The generation of the control flow is specifically described in pages 268 to 270 of “Complier construction and optimization” (Ikuo Nakata, Asakura Shoten (1999)).

### <Processing by the Attribute Information Allocation Table Generating Unit 1320>

After generating the control flow, the control flow generating unit 1310 transmits the generated control flow to the attribute information allocation table generating unit 1320. Then, the attribute information allocation table generating unit 1320 generates an attribute information allocation table 1800 based on the transmitted control flow (step S150).

The attribute information allocation table generating unit 1320 sets an attribute at an entry and an exit of each of the blocks generated by the control flow generating unit 1310. The mapping correspondence table generating unit 1330 (which will be described later) determines mapping information corresponding to the attribute and the mapping information is set to an entry and an exit of each of the blocks. Hereinafter, an attribute set to an entry is referred to as “entry attribute”, and an attribute set to an exit is referred to as “exit attribute”.

When setting an attribute at an entry and an exit of each of the blocks, if there is a branch between a first block and a second block, mapping information corresponding to an exit attribute of the first block and mapping information corresponding to an entry attribute of the second block are same.

In the control flow shown in FIG. 8, for example, there is the branch indicated by the edge 1 between the node 1 corresponding to the block B1 and the node 2 corresponding to the block B2. Therefore, same attributes are set to an exit attribute of the block B1 and an entry attribute of the block B2.

In other words, attributes are allocated to each edge so that same attributes are allocated to an entry and an exit located at respective ends of the edge.

Also, one attribute is allocated to each group of edges connected to each other.

For example, same attributes are allocated to the edges 4 and 5 connected to each other at an exit of the node 3, to the edges 4 and 2 connected to each other at an entry of the node 3, and to the edges 2 and 1 connected to each other at an exit of the node 1.

As a result of allocating the same attributes to these edges, the attributes at the entries and exits located at respective ends of the edges 1, 2, 4, and 5 are same. More specifically, the attributes at the exit of the node 1, at the entry of the node 2, at the entry and the exit of the node 3, and at the entry of the node 4 are same.

FIG. 9 shows a generation process of the attribute information allocation table 1800 generated by the attribute information allocation table generating unit 1320, and examples of a structure and the content of the attribute information allocation table 1800.

The attribute information allocation table 1800 is composed of a block 1810, en edge 1820, and an attribute 1830.

The block 1810 indicates an entry and an exit of each of the blocks B1 to B5. The edge 1820 indicates edge numbers to which an entry and an exit of each of the blocks are connected. For example, “1” indicates the edge 1. Also, the attribute 1830 indicates attributes set to an entry and an exit of each of the blocks.

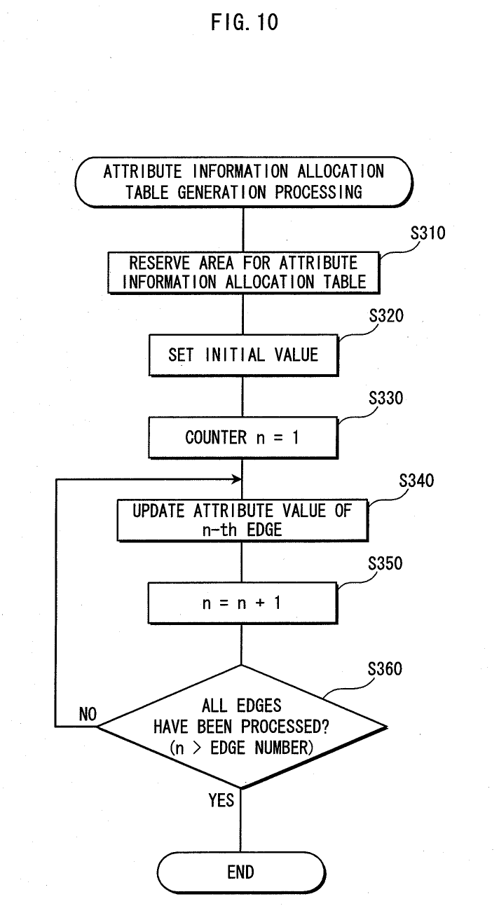

The following describes a method of determining these attributes, with reference to FIG. 10.

FIG. 10 is a flowchart showing attribute information allocation table generation processing.

Firstly, the attribute information allocation table generating unit 1320 generates a table having columns that are twice as many as the number of blocks generated by the control flow generating unit 1310 (step S310).

Here, because the number of blocks generated by the control flow generating unit 1310 is 5, the attribute information allocation table generating unit 1320 generates a table having 10 columns (refer to FIG. 9).

Then, the attribute information allocation table generating unit 1320 sets different numerical values to the columns of the attribute 1830 as initial values in ascending order. More specifically, the attribute information allocation table generating unit 1320 sets the initial values “1”, “2”, . . . , “10” to the columns of the attribute 1830 from a column corresponding to “entry of block B1” to a column corresponding to “exit of block B5” of the block 1810 (step S320, refer to the attribute 1830 in FIG. 9).

After setting the initial values, the attribute information allocation table generating unit 1320 sets “1” to a counter “n” for counting the number of times of repeating steps S340 to S360 (step S330).

Next, the attribute information allocation table generating unit 1320 compares (i) a value “A” in a column of the attribute 1830 corresponding to an exit of a block whose exit is connected to an edge “n” (“n” indicates a value in a column of the edge 1820), i.e. a block that is a starting point of the edge “n” with (ii) a value “B” in a column of the attribute 1830 corresponding to an entry of a block whose entry is connected to the edge “In”, i.e. a block that is an ending point of the edge “n”. Here, the larger value is defined as “X”, and the smaller value is defined as “Y”. Then, the attribute information allocation table generating unit 1320 replaces “X” with “Y” in the attribute information allocation table 1800 (step S340).

For example, in the case of “n==1”, a block whose exit is connected to the edge 1 is the block B1, and a block whose entry is connected to the edge 1 is the block B2. A value in a column of the attribute 1830 corresponding to “exit of block B1” is “2”. Also, a value in a column of the attribute 1830 corresponding to “entry of block B2” is “3”. Then, the attribute information allocation table generating unit 1320 replaces “3” with “2” that is the smaller value. In other words, the value in the column of the attribute 1830 of the entry of the block B2 is changed from “3” to “2” (refer to an attribute 1801).

Then, the attribute information allocation table generating unit 1320 increments a value of “n” (step S350).

The attribute information allocation table generating unit 1320 judges whether or not the value of “n” is larger than the total number of the edges, i.e. “6” in the first embodiment. When the value of “n” is larger than the total number of the edges (“YES” in step S360), the attribute information allocation table generating unit 1320 ends the processing because the processing has been completed for all of the edges. When the value of “n” is smaller than the total number of the edges (“NO” in step S360), the attribute information allocation table generating unit 1320 continues performing the processing on a next edge (step S340).

In the case of “n==2”, the attribute information allocation table generating unit 1320 compares (i) a value of an attribute “2” of the exit of the block BE that is a starting point of the edge 2 with (ii) a value of an attribute “5” of an entry of the block B3 that is an ending point of the edge 2, and defines “5” as the larger value “X” and “2” as the smaller value “Y”. Then, the attribute information allocation table generating unit 1320 replaces “5” with “2” in the attribute information allocation table 1800 (refer to an attribute 1802), and updates the values in the 10 columns of the attribute 1830 to “1,2,2,4,2,6,7,8,9,10”.

In the same manner as this, in the case of “n==3”, because a value of an attribute of the exit of the block B2 that is a starting point of the edge 3 is “4” and a value of an attribute of an entry of the block B5 that is an ending point of the edge 3 is “9”, the attribute information allocation table generating unit 1320 replaces “9” with “4” in the attribute information allocation table 1800 (refer to an attribute 1803), and updates the values in the 10 columns of the attribute 1830 to “1,2,2,4,2,6,7,8,4,10”.

The attribute information allocation table generating unit 1320 continues performing the same processing until the case of “n==6”, replaces a value of an attribute “8” of an exit of the block B4 with a value of an attribute “4” of an entry of the block B5 in the attribute information allocation table 1800 (refer to an attribute 1804) and updates the values in the 10 columns of the attribute 1830 to “1,2,2,4,2,2,2,4,4,10” (refer to an attribute 1831).

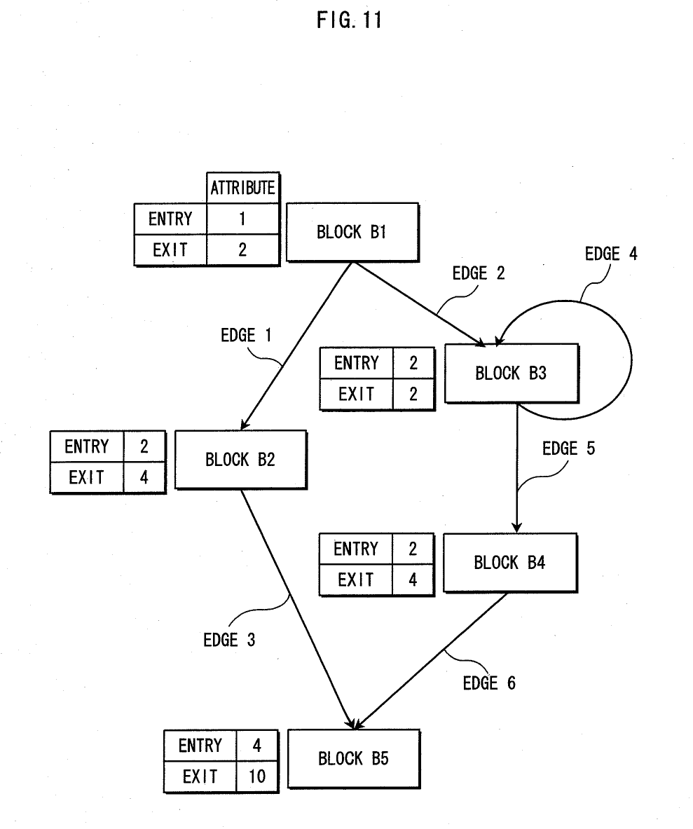

FIG. 11 is a control flow showing the attributes set to the entry and the exit of each of the blocks.

### <Processing by the Mapping Correspondence Table Generating Unit 1330>

After generating the attribute information allocation table 1800, the attribute information allocation table generating unit 1320 transmits the generated attribute information allocation table 1800 to the mapping correspondence table generating unit 1330. Then, the mapping correspondence table generating unit 1330 generates a mapping correspondence table 1900 in which each of the attributes in the transmitted attribute information allocation table 1800 is in correspondence with mapping information (step S160).

The mapping correspondence table 1900 indicates the mapping information corresponding to each of the attributes in the attribute information allocation table 1800. Therefore, the mapping information allocated to each of the blocks can be obtained by referring to the mapping correspondence table 1900.

Also, the attribute information allocation table 1800 and the mapping correspondence table 1900 are generated in a memory that is not shown.

The mapping correspondence table generating unit 1330 generates pieces of mapping information same as the number of the attributes in the attribute 1831 composing the attribute information allocation table 1800.

FIG. 12 shows an example of a structure and the content of the mapping correspondence table 1900.

An attribute 1950 is a list of the attributes in the attribute 1831 finally obtained in the attribute information allocation table 1800. Also, the mapping correspondence table 1900 is composed of an ID 1910 and mapping information 1920. The ID 1910 is an identifier of the mapping information 1920 and corresponds to the attribute 1950 (refer to dotted arrows in FIG. 12).

In the first embodiment, the number of types of the attributes in the attribute 1831 finally obtained in the attribute information allocation table 1800 is four, i.e. “1”, “2”, “4”, and “10” (refer to FIG. 9). Therefore, the mapping correspondence table generating unit 1330 generates four types of pieces of mapping information.

The following describes a procedure of generating the mapping information 1920 by the mapping correspondence table generating unit 1330, using concrete examples.

Firstly, the mapping correspondence table generating unit 1330 sets the mapping information 1920 corresponding to an entry attribute of a block that is a starting point of a control flow, based on the initial values of the additional variables added by the variable adding unit 1100.

In the first embodiment, the entry attribute of the block B1 that is the starting point is “n” (refer to FIG. 11), and the initial values of the additional variables “pm_{—}0” and “pm_{—}1” are “0” and “1” respectively.

Therefore, the mapping correspondence table generating unit 1330 generates mapping information in which the initial values of “pm_{—}0” and “pm_{—}1” are “pm_{—}0_after” and “pm_{—}1_after”, as the mapping information 1920 of “F1” in one of columns of the ID 1910 (hereinafter, referred to as “mapping information F1”) corresponding to “1” in one of columns of the attribute 1950.

That is to say, “pm_{—}0 after=0; pm_{—}1_after=1” is the mapping information F1 (refer to “F1” in one of the columns of the ID 1910 in FIG. 12).

Then, the mapping correspondence table generating unit 1330 randomly generates mappings for the attributes “2”, “4”, and “10” other than the entry attribute of the starting point.

In the first embodiment, the mapping correspondence table generating unit 1330 generates mapping information in which a random value pm_X satisfying pm_XεPM_X (X=0, 1) is a value of pm_X_after, as mapping information corresponding to the attributes “2”, “4”, and “10”.

In the first embodiment, the mapping information F2 corresponding to the attribute “2” is “pm_{—}0_after=30; pm_{—}1_after=6;”, the mapping information F4 corresponding to the attribute “4” is “pm_{—}0_after=12; pm_{—}1_after=7;”, and the mapping information F10 corresponding to the attribute “10” is “pm_{—}0_after=13; pm_{—}1_after=31;” (refer to the mapping correspondence table 1900 in FIG. 12).

### <Processing by the Block Converting Unit 1400>

After generating the mapping correspondence table 1900, the mapping correspondence table generating unit 1330 transmits the generated mapping correspondence table 1900 to the block converting unit 1400. Then, the block converting unit 1400 adds program instructions to each of the blocks based on the transmitted mapping correspondence table 1900 to generate converted blocks (step S170).

The block converting unit 1400 performs the processing in the step S170 on all of the blocks B1 to B5 until the program instructions are added to each of the blocks (step S180).

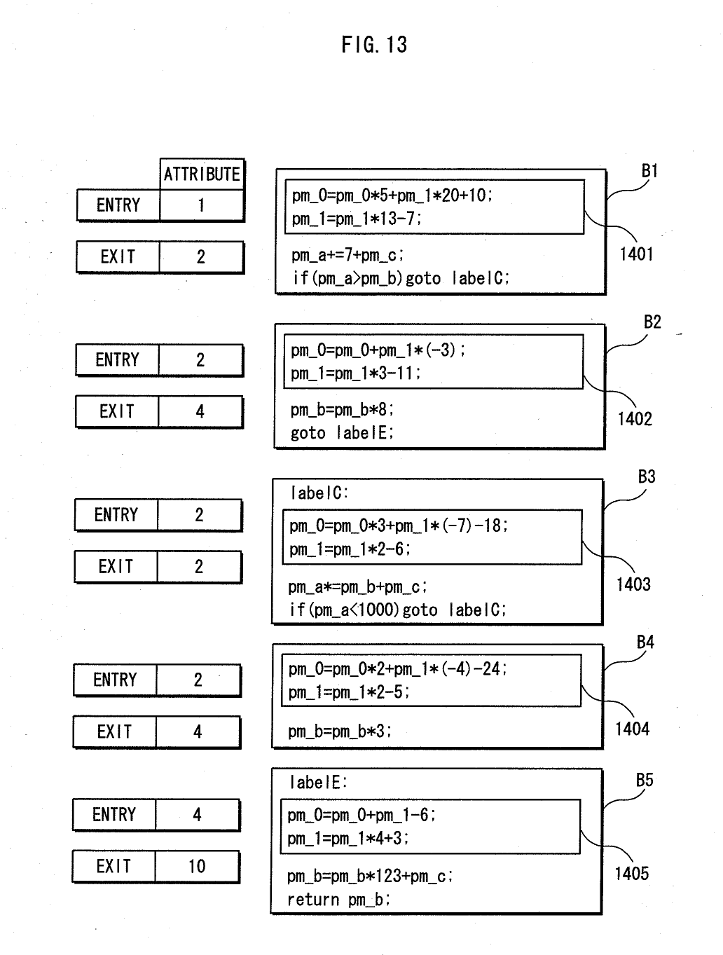

FIG. 13 shows the converted blocks generated by the block converting unit 1400 by converting the blocks B1 to B5. Program instruction groups 1401 to 1405 indicate the program instructions added to the blocks B1 to B5 respectively.

The block converting unit 1400 adds another function to an original function that has been held by a block in advance in order to generate a converted block.

Here, the added another function converts a value of an additional variable to a value indicated by exit mapping information, when the value of the additional variable is a value indicated by entry mapping information. More specifically, the block converting unit 1400 adds a program instruction for executing such a function.

The following describes a concrete example of the added function. After that the generation of the program instructions for realizing the added function will be described.

### <Added Function>

Firstly, a function added to the block B1 will be described.

The function added to the block B1 converts the mapping information F1 to the mapping information F2 (refer to FIG. 11). Note that a program instruction group for realizing this function is referred to as “G_1_2”.

The entry mapping information F1 of the block B1 is “pm_{—}0_after=0; pm_{—}1_after=1;”, and the exit mapping information F2 of the block B1 is “pm_{—}0_after=30; pm_{—}1_after=6;” (refer to the mapping correspondence table 1900 in FIG. 12).

Therefore, the function added to the block B1 converts values of (pm_{—}0, pm_{—}1) so that the values of (pm_{—}0, pm_{—}1) are equal to values (30, 6) of (pm_{—}0, pm_{—}1) indicated by (pm_{—}0_after, pm_{—}1_after) of the exit mapping information F2, when the values of (pm_{—}0, pm_{—}1) are the values (0, 1) of (pm_{—}0_after, pm_{—}1_after) in the entry mapping information F1.

More specifically, the added function is realized by an instruction group in which “pm_{—}0=30”, “pm_{—}1=6” when “pm_{—}0=0”, “pm_{—}1=1”, and the program instruction group G_1_2 is “pm_{—}0=pm_{—}0*5+pm_{—}1*20+10; pm_{—}1=pm_{—}1*13−7;” (refer to the program instruction group 1401).

Note that a method of generating such an instruction will be described later.

When the values of (pm_{—}0, pm_{—}1) are the values (0, 1) of (pm_{—}0_after, pm_{—}1_after) in the entry mapping information F1 by adding the program instruction group G_1_2, i.e. the program instruction group 1401, the program instruction group 1401 “pm_{—}0=0*5+1*20+10; pm_{—}1=1*13−7;” is executed. As a result, (pm_{—}0, pm_{—}1)=(30, 6). The values are equal to the values of (pm_{—}0, pm_{—}1) indicated by (pm_{—}0_after, pm_{—}1_after) of the exit mapping information F2.

Further, the program instruction group having the same function is added to each of the other blocks B2 to B5.

In other words, the program instruction groups 1402 to 1405 are also the program instruction groups for performing the processing in which the values of (pm_{—}0, pm_{—}1) are (pm_{—}0_after, pm_{—}1_after) in exit mapping information of each of the blocks if the values of (pm_{—}0_after, pm_{—}1_after) in entry mapping information of each of the blocks are assigned (refer to FIG. 13).

### <Generation of Added Processing>

The following specifically describes the method of generating the above-mentioned program instruction group G_1_2.

The following describes a case of generating an instruction group G_IN_OUT for a block having F_IN as entry mapping information and F_OUT as exit mapping information.

For example, F_IN and F_OUT are F1 and F2 respectively when generating an instruction group added to the block B1. Also, F_IN and F_OUT are F_2 and F_4 respectively when generating an instruction group added to the block B2.

Firstly, randomly generated constants are defined as R1, R2, and R3. Also, an expression 1 is defined as “pm_{—}0_after−pm_{—}0_before*R1−pm_{—}1_before*R2”, and an expression is defined as “pm_{—}1_after−pm_{—}1 before*R3”.

Then, the values of (pm_{—}0_after, pm_{—}1_after) of the exit mapping information F_OUT are assigned to (pm_{—}0_after, pm_{—}1_after), and the values of (pm_{—}0_after, pm_{—}1_after) of the entry mapping information F_IN are assigned to (pm_{—}0 before, pm_{—}1_before), in order to calculate values of the expressions 1 and 2. Then, the values of the expressions 1 and 2 are defined as V1 and V2 respectively.

By using the calculated values V1 and V2, the additional program instruction group G_IN_OUT is “pm_{—}0=pm_{—}0*R1+pm_{—}1*R2+V1; pm_{—}1=pm_{—}1*R3+V2”.

The following describes a concrete example of processing of generating the additional program instruction group G_1_2 added to the block B1, in which R1, R2, and R3 are defined as “5”, “20”, and “13” respectively.

When the above-mentioned values of R1, R2, and R3 are assigned to the expressions 1 and 2, the expression 1 is “pm_{—}0_after−pm_{—}0 before*5−pm_{—}1_before*20”, and the expression 2 is “pm_{—}1_after−pm_{—}1_before*13”.

In the above-mentioned expressions, the values (30, 6) of the exit mapping information F2 are assigned to (pm_{—}0_after, pm_{—}1_after), and the values (0, 1) of the entry mapping information F1 are assigned to (pm_{—}0_before, pm_{—}1_before). As a result, the expressions are “30−0*5−1*20” and “6−1*13” respectively. In other words, V1 and V2 are “10” and “−7” respectively.

Therefore, the program instruction group G_1_2 is “pm0=pm0*5+pm1*20+10:pm_{—}1=pm_{—}1*13−7;”. The additional program instruction group G_1_2 generated by the above-mentioned method is added to the beginning of the block B1 to generate the converted block (refer to the program instruction group 1401 in FIG. 13).

### <Processing by the Secret Block Converting Unit 1500>

After generating the converted block, the block converting unit 1400 transmits the generated converted block to the secret block converting unit 1500. Then, the secret block converting unit 1500 specifies a secret block including the secret information in the transmitted converted block (step S190), and replaces the secret information with an expression for calculating the secret information using the additional variables to generate an obfuscated program (step S200).

Here, as a method of specifying the secret block, the secret information is detected from the target program 2000 and a block including the secret information is specified as the secret block.

As a method of detecting the secret information, the secret information has been enclosed in a predetermined code in advance, the secret information is specified by a user before starting obfuscation, or the like in order that the secret block converting unit 1500 can recognize the secret information. Also, a plurality of pieces of secret information may be included in the secret block, and a plurality of pieces of the secrete blocks may be included in the target program.

Then, the secret block converting unit 1500 converts the secret information included in the program to a program instruction for calculating the secret information using the additional variables added by the variable adding unit 1100.

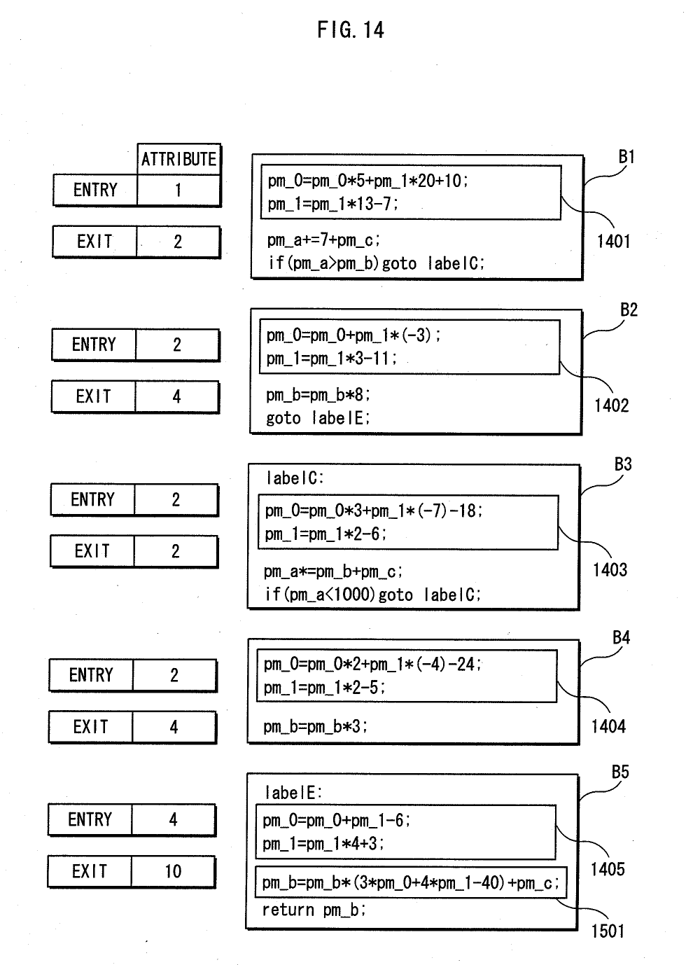

FIG. 14 shows the obfuscated program 3000 including the converted secret block generated by the above-mentioned method.

The following describes a method of obtaining the program instruction for calculating the secret information using the additional variables.

Firstly, randomly generated constants are defined as R4 and R5, and the following expression 3 is generated. The expression 3 is “pm_{—}0_after−pm_{—}0_before*R4−pm_{—}1_before*R5”. Then, the value of the secret information is assigned to “pm_{—}0_after”, and the values of (pm_{—}0_after, pm_{—}1_after) of the exit mapping information F_OUT of the secret block are assigned to (pm_{—}0_before, pm_{—}1_before), in order to calculate a value of the expression 3. Then, the calculated value is defined as V3.

Here, a conversion of the value “123” of the secret information included in the block B5 that is the secret block (refer to FIG. 13) will be described as an example.

The block including the secret information “123” is the block B5, and (pm_{—}0_after, pm_{—}1_after) of the exit mapping information F10 of the block B5 is (13, 31).

R4 and R5 are defined as “3” and “4” respectively, and these values are assigned to the expression 3 to obtain “123−13*3−31*4”. As a result, “−40” that is a value of V3 can be obtained from “123−13*3−31*4”.

Next, the value of the secret information is replaced with “(pm_{—}0*R3+pm_{—}1*R4+V3)”. That is to say, the program instruction “b=b*123” is replaced with “b=b*(3*pm_{—}0+4*pm_{—}1−40);” (refer to a program instruction 1501 in FIG. 14).

Here, the above-mentioned finally obtained expression is an expression in which the values of (pm_{—}0 before, pm_{—}1_before) are multiplied by the random numbers R3 and R4 respectively and the values are added to each other. Then, V3 is added to the added value that is an operation result.

As mentioned above, as the calculation result of the above-mentioned expression, the secret information “123” can be always obtained when the entry attribute is “4” that is the value indicated in the column of the attribute 1831 in the attribute information allocation table 1800 (refer to FIG. 9).

The obfuscated program 3000 includes the block B5 generated by the secret block converting unit 1500 by converting the secret information and the converted blocks B1 to B4 generated by the block converting unit 1400.

The obfuscated program 3000 is outputted to the external memory 13 by the output unit (step S210).

### <Effect of the First Embodiment>

The first embodiment showed the example of the obfuscation of the program by converting the program so that the secret information is calculated by executing the plurality of program instructions. This obfuscation method has the following three features.

(i) An entry attribute F_IN of a block that is a starting point of a control flow, for example, the block B1 is defined as an initial value of an additional variable (refer to the processing by the mapping correspondence table generating unit 1330).

(ii) When the additional variable is a value indicated by entry mapping information F_IN of each of the blocks, a function of converting the value to a value indicated by exit mapping information of the block is added to the block (refer to the processing by the block converting unit 1400).

(iii) In the case of a node having a plurality of branch source nodes, entry mapping information of a block corresponding to the node is equal to exit mapping information of blocks corresponding to the branch source nodes (refer to the attribute information allocation table 1800). For example, the block B5 has two branch source blocks B2 and B4. In this case, exit mapping information of each of the blocks B2 and B4 is equal to entry mapping information of the block B5 (refer to FIG. 11).

Because of the above three features, even if an obfuscated program is executed by taking any execution route when the program is executed in a normal system, a value of an additional variable is a value indicated by entry mapping information set to the secret block in (ii).

Therefore, a value of the secret information calculated based on the entry mapping information of the block B5 including the secret information is always a correct value “123”, even if an obfuscated program is executed by taking any execution route when the program is executed in a normal system.

In the obfuscated program of the first embodiment, the program instructions for calculating the values of the additional variables are added to all of the blocks. Also, the secret information is calculated by using the additional variables. Therefore, if an unauthorized analyst tries to analyze the value of the secret information by finding the added program instructions, it is difficult to find all of the added program instructions because the added program instructions are diffused in various places in the program. Thus, it takes a long time to find the secret information, resulting in the secret information being protected.

### Second Embodiment

### Outline

In the first embodiment, the new variables are added, the program instructions for calculating the values of the additional variables are added to all of the blocks, and the secret information is replaced with the expression for calculating the secret information using the additional variables in order to generate the obfuscated program. On the other hand, in a second embodiment, variables that have been originally included in a target program are used, and roles of the variables are replaced in the middle of the program to generate an obfuscated program.

Here, a difference between the first embodiment and the second embodiment will be described.

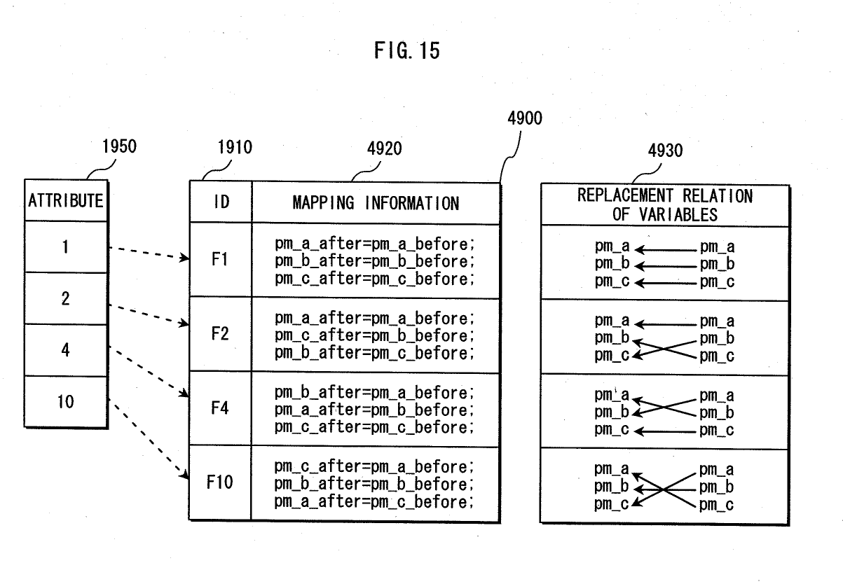

The second embodiment is different from the first embodiment in that mapping information is different. FIG. 15 shows a mapping correspondence table 4900 of the second embodiment.

The mapping correspondence table 4900 is composed of the ID 1910 and mapping information 4920. The ID 1910 is an identifier of the mapping information 4920 same as in the first embodiment. Also, a replacement relation of variables 4930 does not compose the mapping correspondence table 4900. However, the replacement relation of variables 4930 shows a replacement relation of variables by using arrows for convenience of an explanation.

In other words, in the mapping correspondence table 1900 in the first embodiment (refer to FIG. 12), a value of the variable is determined according to each of the attributes. However, in the second embodiment, it is determined that a value of a certain variable is replaced with a value of which variable according to each attribute.

### <Structure>

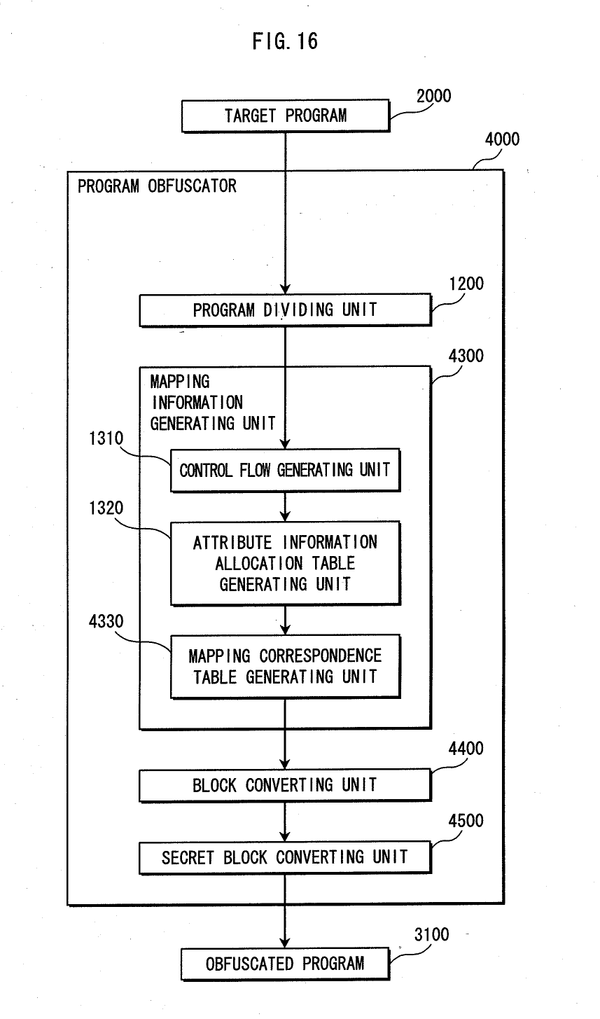

FIG. 16 is a block diagram showing a structure example of a program obfuscator 4000 of the second embodiment.

The program obfuscator 4000 has the following four different points from the program obfuscator 1000 (refer to FIG. 2) of the first embodiment.

Firstly, the program obfuscator 4000 does not include the variable adding unit 1100. Secondly, the content of a mapping generated by a mapping correspondence table generating unit 4330 of a mapping information generating unit 4300 is different. Thirdly, a method of generating a program instruction group added by a block converting unit 4400 is different because the content of the mapping is different. Fourthly, a method of calculating secret information by a secret block converting unit 4500 is different because an additional variable is not added.

### <Operation>

The following describes processing by the mapping correspondence table generating unit 4330, the block converting unit 4400, and the secret block converting unit 4500 of the mapping information generating unit 4300. Note that other operations are same as in the first embodiment (refer to FIG. 5 and the like).

### <Processing by the Mapping Correspondence Table Generating Unit 4330 of the Mapping Information Generating Unit 4300>

The mapping information generating unit 4300 generates mapping information set to an entry and an exit of each of the blocks generated by the program dividing unit 1200.

The following simply describes the mapping information set in the second embodiment.

The mapping information is the following mapping. When a set of elements that are values to be taken by pm_X (X=a, b, c) is defined as a set PM_X (X=a, b, c), the mapping causes (pm_a_before, pm_b_before, pm_c before) satisfying pm_a_beforeεPM_A, pm_b_beforeεPM_B, pm_c_beforeεPM_C to correspond to (pm_a_after, pm_b_after, pm_c_after) satisfying pm_a_afterεPM_A, pm_b_afterεPM_B, pm_c_afterεPM_C. Also, the mapping replaces roles of the variables.

For example, when values of variables (pm_a, pm_b, pm_c) are (pm_a_before, pm_b_before, pm_c_before) respectively, mapping information “pm_a after=pm_a_before; pm_b_after=pm_c_before; pm_c_after=pm_b_before;” indicates a mapping for assigning each of the values to variables (pm_a_after, pm_c_after, pm_b_after). That is to say, the above-mentioned mapping information indicates the mapping in which roles of the variables (pm_a, pm_b, pm_c) are replaced with (pm_a, pm_c, pm_b) respectively.

### <Processing by the Mapping Correspondence Table Generating Unit 4330>

The mapping correspondence table generating unit 4330 generates the mapping correspondence table 4900 indicating mapping information corresponding to each of the attributes in the attribute information allocation table 1800 same as in the first embodiment.

Note that the attribute information allocation table 4900 of the second embodiment is same as the attribute information allocation table 1800 of the first embodiment (refer to FIG. 9).

The mapping correspondence table generating unit 4330 generates pieces of mapping information same as the number of types of the attributes composing the attribute information allocation table 1800, i.e. four types of pieces of mapping information.

For example, each of the pieces of the mapping information is generated as follows.

The mapping correspondence table generating unit 4330 causes one of the variables randomly selected from pm_a_before, pm_b_before, pm_c_before to correspond to pm_a_after, causes one of the variables randomly selected from the remaining variables to correspond to pm_b_after, and causes the last remaining variable to correspond to pm_c_after.

For example, when “pm_a_before, pm_c_before” are selected in this order, the mapping information is “pm_a after=pm_a_before; pm_b after=pm_c_before; pm_a_after=pm_b_before;”.

In the second embodiment, the mapping information F1 corresponding to the attribute “1” of the entry mapping information of the block B1 that is the starting point of the control flow shown in FIG. 11 is “pm_a_after=pm_a_before; pm_b_after=pm_b_before; pm_c_after=pm_c_before;”.

Also, the mapping correspondence table generating unit 4330 sequentially determines mapping information corresponding to each of other attributes “2”, “4”, and “10” and completes the mapping correspondence table 4900.

### <Processing by the Block Converting Unit 4400>

The block converting unit 4400 adds another function to an original function that has been held by a block in advance in order to generate a converted block. The additional function replaces a variable indicating exit mapping information when a variable indicating entry mapping information has been replaced. Also, this replacement is performed using a variable used in an original program instruction.

The following describes the additional function and the replacement of the variables. After that, a method of generating a program instruction for realizing the additional function will be described.

### <Additional Function>

The following describes the function added to a block by using a concrete example.

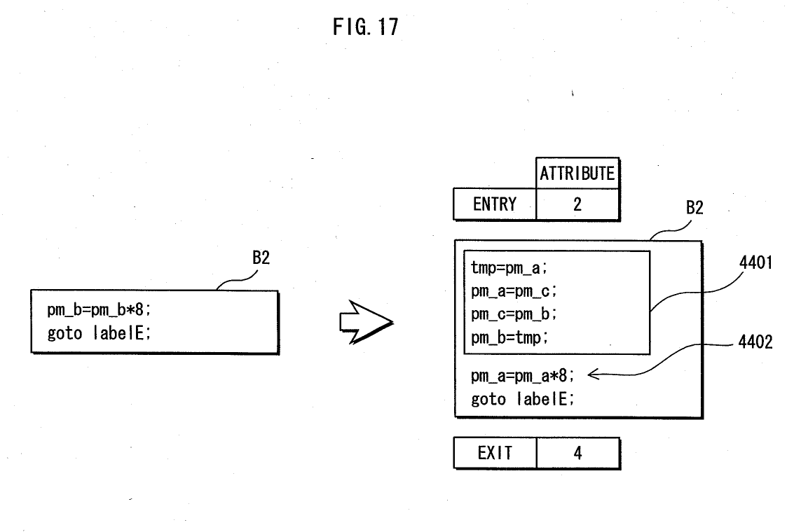

FIG. 17 shows a converted block B2 generated by the block converting unit 4400 by converting the block B2 in FIG. 7.

In FIG. 17, the block B2 before the conversion (hereinafter, referred to as “pre-conversion block B2”) is shown on the left side of an arrow, and the block B2 after the conversion (hereinafter, referred to as “converted block B2”) is shown on the right side of the arrow.

The converted block B2 is generated by adding a program instruction group G_2_4 “tmp=pm_a; pm_a=pm_c; pm_c=pm_b; pm_b=tmp;” for replacing roles of variables (refer to a program instruction group 4401 in FIG. 17) to the pre-conversion block B2, and replacing the variable included in the pre-conversion block B2 based on the exit mapping information F4 (refer to a program instruction group 4402 in FIG. 17).

The program instruction group G_2_4 is for replacing roles of the variables. Also, the program instruction group G_2_4 replaces the variable based on exit mapping information when roles of the variables are replaced based on entry mapping information before the block B2 is executed in a normal system.

The following describes that the program instruction group G_2_4 indicated by the program instruction group 4402 has the above-mentioned feature.

Firstly, as shown in FIG. 11, the entry mapping information of the block B2 is F2 and the exit mapping information thereof is F4.

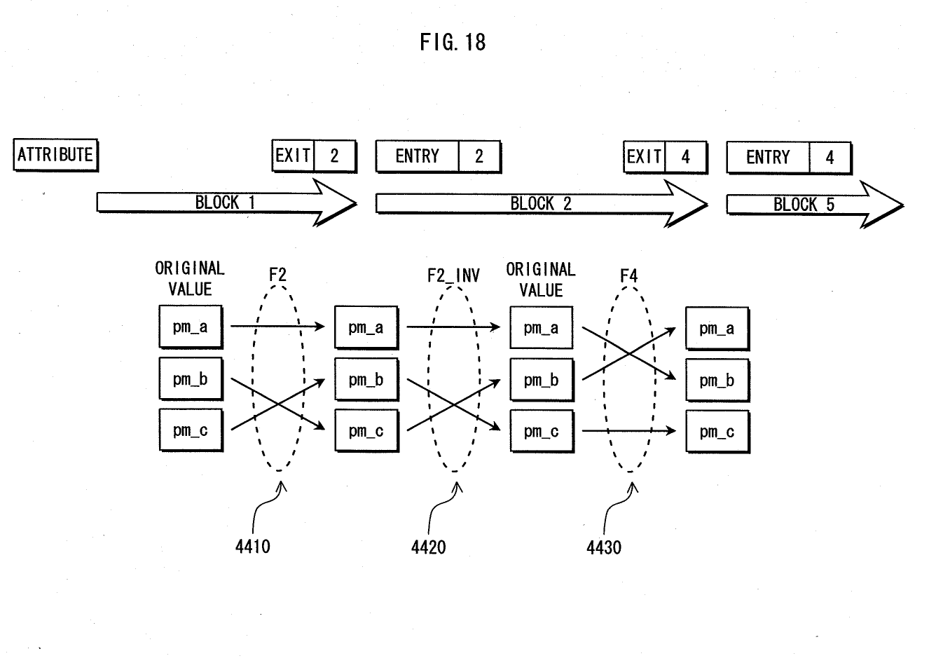

FIG. 18 shows conversions at an entry and an exit of the block B2. Note that F2_INV indicates an inverse mapping of F2 (a conversion 4420).

The entry mapping information F2 is a replacement (a conversion 4410) for replacing roles of the variables (pm_a, pm_b, pm_c) with (pm_a, pm_c, pm_b). The exit mapping information F4 is a replacement (a conversion 4430) for replacing roles of the variables (pm_a, pm_b, pm_c) with (pm_b, pm_a, pm_c) (refer to the mapping correspondence table 4900 in FIG. 15).

Also, the program instruction group G_2_4 “tmp=pm_a:pm_a=pm_c; pm_c=pm_b; pm_b=pm_a;” is processing for replacing the roles of the variables (pm_a, pm_b, pm_c) with (pm_b, pm_c, pm_a).

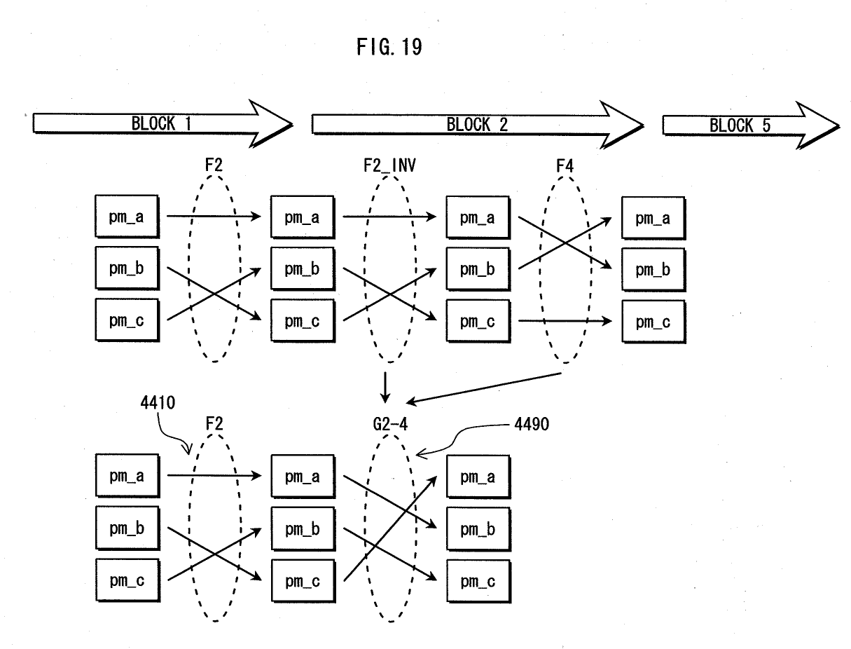

In this case, a lower part of FIG. 19 shows a replacement when both the replacement by the entry mapping information F2 and the replacement by the program instruction group G_2_4 are performed.

As shown in FIG. 19, when the replacement by the entry mapping information F2 (the conversion 4410) is performed, and then the replacement by the program instruction group G_2_4 (a conversion 4490) is further performed, this replacement is same as a replacement of replacing the original (pm_a, pm_b, pm_c) with (pm_b, pm_a, pm_c). This replacement is same as the replacement indicated by the exit mapping information F4.

Note that a method of generating the program instruction group G_2_4 will be described later.

### <Replacement of Variables>

Further, in the block B2, it is required to rewrite the variable included in the block B2 based on the exit mapping information F4.

More specifically, pm_b in “pm_b=pm_b*8;” in the block B2 is replaced with pm_a based on the exit mapping information F4 so as to be “pm_a=pm_a*8;” (refer to the program instruction 4402 in FIG. 17).

### <Generation of Additional Processing>

The following specifically describes a method of generating the program instruction group G_2_4 and the like.

The entry mapping information of a block on which the conversion is performed is defined as F_IN, the exit mapping information is defined as F_OUT, and an inverse conversion of a replacement by the entry mapping information F_IN is defined as F_IN_INV.

For example, when a block on which the conversion is performed is the block B2, F_IN is F2 that is a mapping for causing (pm_a_before, pm_b_before, pm_c_before) to correspond to (pm_a_after, pm_c_after, pm_b_after) (refer to the conversion 4410 in FIG. 18).

In this case, F2_INV is a mapping in which pm_X_after in F_2 is replaced with pm_X_before, and which causes (pm_a_before, pm_b_before, pm_c_before) to correspond to (pm_a_after, pm_c_after, pm_b_after) (refer to the conversion 4420 in FIG. 18).

Then, a replacement by the synthesis of F_IN_INV and F_OUT will be obtained.

For example, when a target block is the block B2, F_OUT is F4 that is a mapping for causing (pm_a_before, pm_b_before, pm_c_before) to correspond to (pm_b_after, pm_a_after, pm_c after) (refer to the conversion 4430 in FIG. 18).

In this case, the replacement by the synthesis of F_IN_INV and F_OUT is a mapping for causing (pm_a_before, pm_b_before, pm_c_before) to correspond to (pm_b_after, pm_c_after, pm_a_after) (refer to the conversion 4490 in FIG. 19).

Then, the program instruction group G_2_4 “tmp=pm_a; pm_a=pm_c; pm_c=pm_b; pm_b=tmp;” for performing the above-mentioned replacement is generated, and is added to the block B2.

After that, the variable included in the block B2 is replaced based on the replacement indicated by the exit mapping information F_OUT.

More specifically, because the exit mapping information F4 corresponding to the block B2 includes “pm_a_after=pm_b_before;”, it is found that the variable pm_b is replaced with the variable pm_a. Therefore, pm_b in the block B2 is replaced with pm_a. That is to say, the expression “pm_b=pm_b*8;” is replaced with “pm_a=pm_a*8;”.

As mentioned above, the converted block B2 is generated. In the same manner as this, the other blocks B1 and B3 to B5 are converted.

By performing such a conversion, each of the blocks always cancels a conversion corresponding to the exit mapping information of a block immediately before the block, and then performs a conversion corresponding to the exit mapping information of the block.

Because of this method, a state of a replacement of a variable in each of the blocks is equal to the state indicated by the mapping information 4920 shown in FIG. 15 when the program is executed in a normal system, even if there are branches and loops in the block.

Also, because a variable included in a block before conversion is replaced based on the exit mapping information, it can be assured that an operation result of each of the blocks is equal to the block before conversion.

### <Processing by the Secret Block Converting Unit 4500>

In the first embodiment, the secret information is obtained by the expression using the additional variables. However, the additional variables are not added in the second embodiment. Therefore, the secret information is not changed in the second embodiment. As a matter of course, a program may be obfuscated by using a converted variable or other variable.

### <Effect of the Second Embodiment>

The second embodiment showed the example of the obfuscation of the program by replacing the roles of the variables in the middle of the program. This obfuscation method has the following four features.

(i) The same variable as in the original program is allocated to the entry mapping information F_IN of the block B2 corresponding to the node 2 that is the starting point of the control flow (refer to the mapping correspondence table generating unit 4330).

(ii) When a replacement of a variable is indicated by the entry mapping information F_IN, the function of replacing a variable indicated by the exit mapping information F_OUT is added to each of the blocks (refer to the processing by the block converting unit 4400).

(iii) In the case of a node (such as the node 5) having a plurality of branch source nodes (the node 2 and the node 4), the entry mapping information of a block corresponding to the node (the node 5) is equal to the exit mapping information of blocks corresponding to the branch source nodes (refer to the attribute information allocation table 1800).

(iv) A variable of each of the blocks is replaced based on the exit mapping information.

Because of the above four features, even if an obfuscated program is executed in a normal system by taking any execution route, a variable becomes a variable on which a replacement indicated by the entry mapping information of the block is performed when the execution control is transferred to each of the blocks.

Because of the obfuscation, the roles of the variables are replaced in various places of the program, and the obfuscation can make it difficult to analyze the program. Also, because the roles of the variables are replaced for each of the blocks, it is difficult to find that a variable in a certain block is which variable in other block. As a result, this can make it difficult to analyze the program.

### Third Embodiment

### Outline

In the second embodiment, the obfuscated program is generated by using the variables that have been included in the target program, and replacing the roles of the variables in the middle of the program. On the other hand, in a third embodiment, the obfuscated program is generated by performing a predetermined operation on a value of a variable, and causing the variable to hold the value obtained as a result of performing the predetermined operation. For example, 14 is added to a variable pm_a. Then, the variable pm_a is caused to hold a value obtained as a result of the addition.

Here, a difference between the second embodiment and the third embodiment will be described.

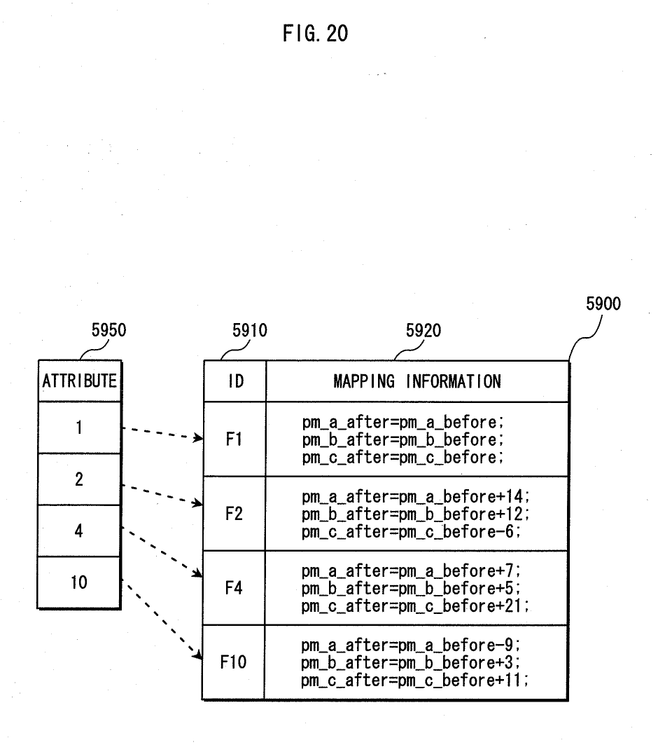

The third embodiment is different from the second embodiment in that mapping information is different. FIG. 20 shows a mapping correspondence table 5900 of the third embodiment.

The mapping correspondence table 5900 is composed of an ID 5910 and mapping information 5920. The ID 5910 is an identifier of the mapping information 5920 same as in the second embodiment.

In other words, in the mapping correspondence table 4900 of the second embodiment (refer to FIG. 15), it is determined that a value of a certain variable is replaced with a value of which variable according to each attribute. However, in the third embodiment, it is determined that what kind of operation is performed on a value of a variable according to each attribute.

### <Structure>

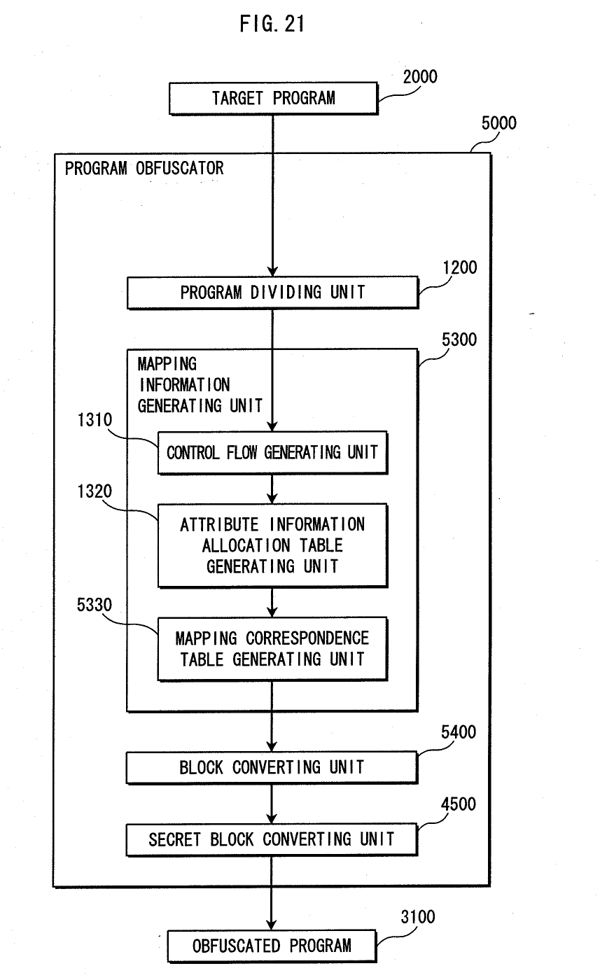

FIG. 21 is a block diagram showing a structure example of a program obfuscator 5000 of the third embodiment.

The program obfuscator 5000 has the following two different points from the program obfuscator 4000 (refer to FIG. 16) of the second embodiment.

Firstly, the content of a mapping generated by a mapping correspondence table generating unit 5330 of a mapping information generating unit 5300 is different. Secondly, a method of generating a program instruction group added by a block converting unit 5400 is different because the content of the mapping is different.

### <Operation>

The following describes processing by the mapping correspondence table generating unit 5330 of the mapping information generating unit 5300 and the block converting unit 5400. Note that other operations are same as in the first embodiment and the second embodiment (refer to FIGS. 5 and 16).

### <Processing by the Mapping Correspondence Table Generating Unit 5330 of the Mapping Information Generating Unit 5300>

Firstly, mapping information set in the third embodiment will be described.

The mapping information of the third embodiment is the following mapping. When a set of elements that are values to be taken by pm_X (X=a, b, c) is defined as a set PM_X (X=a, b, c), the mapping causes (pm_a_before, pm_a_before, pm_c_before) satisfying pm_a_beforeεPM_A, pm_b_beforeεPM_B, pm_c_beforeεPM_C to correspond to (pm_a_after, pm_b_after, pm_c_after) satisfying pm_a_afterεPM_A, pm_b_afterεPM_B, pm_c_afterεPM_C. Also, the mapping causes a value obtained as a result of adding or subtracting a certain value to or from the variable pm_X_before to correspond to pm_X_after.

For example, when values of variables (pm_a, pm_b, pm_c) are (pm_a_before, pm_b_before, pm_c_before) respectively, mapping information “pm_a after=pm_a_before+14; pm_b_after=pm_c_before+12; pm_a_after=pm_b_before−6;” indicates a mapping assigning values of (pm_a before+14, pm_C_before+12, pm_b_before−6) to variables (pm_a, pm_c, pm_b).

That is to say, the above-mentioned mapping indicates a replacement of replacing the roles of the variables (pm_a, pm_b, pm_c) with (pm_a+14, pm_c+12, pm_b−6).

### <Processing by the Mapping Correspondence Table Generating Unit 5330 of the Mapping Information Generating Unit 5300>

The mapping correspondence table generating unit 5330 generates the mapping correspondence table 5900 indicating mapping information corresponding to each of the attributes in the attribute information allocation table 1800 same as in the second embodiment.

Note that the attribute information allocation table 5900 of the third embodiment is same as the attribute information allocation table 1800 of the first embodiment (refer to FIG. 9).

The mapping correspondence table generating unit 5330 generates pieces of mapping information same as the number of types of the attributes composing the attribute information allocation table 1800, i.e. four types of pieces of mapping information.

For example, each of the four types of pieces of the mapping information is generated as follows.

R1, R2, and R3 satisfying R1εPM_A, R2εPM_B, and R3εPM_C respectively are generated and “pm_a_after=pm_a before+R1; pm_b_after=pm_b_before+R2; pm_c_after=pm_c_before+R3;” is defined as the mapping information.

More specifically, the mapping information F1 corresponding to the attribute “1” of the entry mapping information of the block that is the starting point of the control flow shown in FIG. 11 is defined as “pm_a_after=pm_a before; pm_b_after=pm_b_before; pm_c after=pm_c_before;”.

Then, the mapping correspondence table generating unit 5330 determines mapping information corresponding to each of other attributes “2”, “4”, and “10”.

### <Processing by the Block Converting Unit 5400>

The block converting unit 5400 adds another function to an original function that has been held by a block in advance in order to generate a converted block. The additional function replaces a variable indicating the exit mapping information when a variable indicating the entry mapping information has been replaced.

The following describes the additional function, a method of generating a program instruction for realizing the additional function, and the replacement of the variables.

### <Additional Function>

The following describes the function added to a block by using a concrete example.

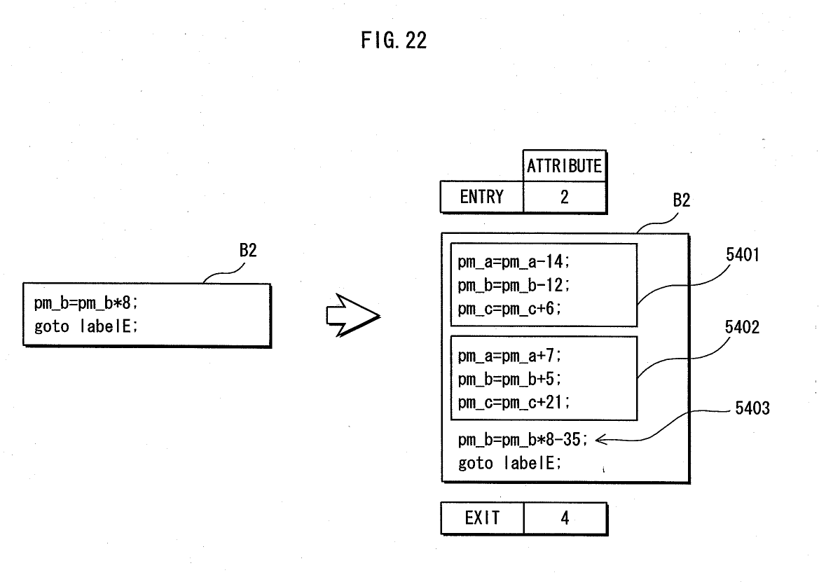

FIG. 22 shows a converted block B2 generated by the block converting unit 5400 by converting the block B2.

In FIG. 22, the pre-conversion block B2 is shown on the left side of an arrow, and the converted block B2 is shown on the right side of the arrow.

More specifically, a program instruction group G_2_INV (refer to a program instruction group 5401 in FIG. 22) is added to the beginning of the pre-conversion block B2, and a program instruction group G_4 (refer to a program instruction group 5402 in FIG. 22) is added after the program instruction group G_2_INV.

Further, the variables included in the block are converted based on the exit mapping information of the block B2 (refer to a program instruction 5403 in FIG. 22).

The program instruction group G_2_INV is “pm_a=pm_a−14; pm_b=pm_b−12; pm_c=pm_c+6;”, and the program instruction group G_4 is “pm_a=pm_a+7; pm_b=pm_b+5; pm_c=pm_c+21;”.

The following specifically describes a method of generating the program instruction group G_2_INV and the program instruction group G_4, and a method of replacing the variables included in the block.

### <Generation of the Program Instruction Group G_2_INV>

The program instruction group G_2_INV is an additional program instruction group for performing an inverse mapping of the entry mapping information F2 of the block B2.

The following describes a method of generating the program instruction group G_2_INV.

Firstly, based on the mapping information F2, an expression for obtaining (pm_a_before, pm_b_before, pm_c_before) using (pm_a after, pm_b_after, pm_c after) is generated.

The generated expression is “pm_a_before=pm_a_after−14; pm_b_before=pm_b_after−12; pm_c_before=pm_c_after+6;”.

In this expression, pm_X_after is replaced with pm_X and pm_X_before is replaced with pm_X. Then, “pm_a=pm_a−14; pm_b=pm_b−12; pm_c=pm_c+6;” is obtained, and is defined as the program instruction group G_2_INV.

### <Generation of the Program Instruction Group G_4>

The program instruction group G_4 is an additional program instruction group for performing a mapping of the exit mapping information F4 of the block B2.

The following describes a method of generating the program instruction group G_4.

In the mapping information F4 “pm_a after=pm_a before+7; pm_b_after=pm_b_before+5; pm_c_after=pm_c_before+21;”, pm_X_after is replaced with pm_X, and pm_X_before is replaced with pm_X.

“pm_a=pm_a+7; pm_b=pm_b+5; pm_c=pm_c+21;” obtained as a result of the replacement is defined as the program instruction group G_4.

### <Replacement of Variables>

The following describes a replacement of the variables included in the block B2.

The replacement of the variables is performed by different conversion methods according to two cases. One of the cases is when a left side of an assignment expression includes a variable (a variable whose value is determined based on an assignment), and the other case is when a right side of the assignment expression includes a variable (which determines a value of an assignment). Note that when both the right side and the left side include variables, both the conversion performed when the right side includes the variable and the conversion when the left side includes the variable are performed.

The following indicates a concrete example of the left side and the right side. In “pm_b=pm_b*8” in the block B2, the left side is “pm_b”, and the right side is “pm_b*8”.

The following describes a replacement of a variable in the left side and a replacement of a variable in the right side by defining “pm_b=pm_b*8” as a replacement target program instruction.

<Replacement when the Left Side Includes a Variable>

When the left side of the program instruction includes a variable, the variable is replaced. Such a conversion is performed because it is required that the exit mapping information is reflected in an operation result of each program instruction.

When the variable pm_X on the left side is replaced, all expressions including pm_X_before are searched in the exit mapping information F_OUT of the block.

Here, when no expression including pm_X_before is found, a conversion is not performed because it is not required to perform a conversion on the program instruction.

In this concrete example, the variable of the left side of the expression “pm_b=pm_b*8” is “pm_b” and the exit mapping information of the block B2 is F4. Therefore, an expression “pm_b_after=pm_b_before+5” including pm_b_before is found.

Then, pm_X_before in the found expression is replaced with the content of the right side of the replacement target program instruction. Here, pm_b_before is replaced with “(pm_b*8)”. As a result, “pm_b_after=(pm_b*8)+5” is obtained.

After that, “pm_b_after” is converted to “pm_b” to obtain an expression “pm_b=(pm_b*8)+5;”.

This expression causes an exit mapping “pm_b_after=pm_b_before+5;” to be reflected in an operation result of the original expression. In other words, this expression is obtained by adding “+5” that is an influence of the exit mapping information to the original expression “pm_b*8”.

Note that in the above example, when the variable of the left side is pm_X (X=a, b, c), and a plurality of expressions including pm_X_before are in the mapping information, the target program instruction is replaced with a program instruction composed of the plurality of expressions. Then, pm_X_before in each of the plurality of expressions is replaced with the content of the right side of the replacement target program instruction.

The above-mentioned explanation is about the replacement when the left side includes a variable.

<Replacement when the Right Side Includes a Variable>

When the right side of the program instruction includes a variable, the variable is replaced.

Such a conversion is performed because of the following reason. Since a variable included in the right side of the program instruction has been converted by the entry mapping, a proper calculation result cannot be obtained even if an operation is performed using the original expression. That is to say, the expression is modified so as to obtain a proper result by removing the influence of the entry mapping from the variable included in the right side of the program instruction.

The following shows an example of replacing a variable of the right side of “pm_b=(pm_b*8)+5;” that is generated in the replacement when the left side includes the variable as described above.

Firstly, F4_INV that is the inverse mapping of the exit mapping information F4 of the block B2 is generated by the above-mentioned method.

Here, F4_INV is “pm_a_before=pm_a_after−7; pm_b_before=pm_b_after−5; pm_a_before=pm_a_after−21;”.

Next, the variable pm_X on the right side of the program instruction is replaced with pm_X_before. In other words, “pm_b=(pm_b*8)+5;” is replaced with “pm_b=(pm_b_before*8)+5;”.

Then, an expression including pm_X before is searched from F4_INV. Here, when the expression including pm_X_before is not found, it indicates that there is no entry mapping information corresponding to the variable pm_X, i.e. the variable pm_X has not been converted. Therefore, pm_X_before in the replaced expression is returned to the variable pm_X, and the processing is completed.

Here, because “pm_b_before” is included in the right side of “pm_b=(pm_b_before*8)+5;”, “pm_b_before=pm_b_after−5;” corresponding to “pm_b_before” is found.

Then, pm_X_before is replaced with an expression using pm_X_after based on the found expression. In other words, “pm_b=(pm_b_before*8)+5;” is replaced with “pm_b=((pm_b_after−5)*8)+5;”.

Finally, pm_X_after is replaced with pm_X. In other words, “pm_b=((pm_b_after−5)*8)+5;” is replaced with “pm_b=((pm_b−5)*8)+5;”.

Note that when a plurality of program instructions including pm_b_before on the right side, pm_b_before of each of the plurality of program instructions is replaced with (pm_b_after−5).

When pm_a_before and pm_b_before are included in one program instruction, pm_a_before is replaced with (pm_a after−7), and pm_b_before is replaced with (pm_b_after−5). For example, pm_b=pm_a_before*pm_b_before is replaced with pm_b=(pm_a_after−7)*(pm_b_after−5).

“pm_b=((pm_b−5)*8)+5;” generated by the above-mentioned method is a result of replacing the variable of the right side. Because of such a conversion, the conversion “pm_b_after=pm_b_before+5” indicated by the entry mapping information is removed by “pm_b−5”.

Note that an operation of constants can be performed in advance. Therefore, the expression can finally be “pm_b=pm_b*8−35;” in which the constants are combined.

The above explanation is about the replacement of the variables included in the block.

### <Effect of the Third Embodiment>

The third embodiment showed the example of the obfuscation of the program by replacing the roles of the variables in the middle of the program. This obfuscation method has the following three features.

(i) The same variable as the original program is allocated to the entry mapping information F_IN of the block B2 that is the starting point of the control flow (refer to the mapping correspondence table generating unit 5330).

(ii) When a replacement of a variable is indicated by the entry mapping information F_IN, the function of replacing a variable indicated by the exit mapping information F_OUT is added to each of the blocks (refer to the processing by the block converting unit 5400).

(iii) In the case of a block (such as the block B5) having a plurality of branch source blocks (the block B2 and the block B4), the entry mapping information of the block is equal to the exit mapping information of the branch source blocks (refer to the attribute information allocation table 1800).

Because of the above three features, even if an obfuscated program is executed in a normal system by taking any execution route, a replacement of a variable is a replacement of a variable indicated by the entry mapping information of the block when each of the blocks includes branches.

Because of the obfuscation, the roles of the variables are replaced in various places of the program, and the obfuscation can make it difficult to analyze the program. Also, because the roles of the variables are replaced for each of the blocks, it is difficult to find that a variable in a certain block is which variable in other block. As a result, this can make it difficult to analyze the program.

### Fourth Embodiment

### Outline

In the first to third embodiments, the obfuscated program is generated by adding the program instructions to the target program and replacing the roles of the variables, i.e. changing the values of the variables, in order to secure the confidentiality of software. On the other hand, in a fourth embodiment, the confidentiality is secured by encrypting a block.

That is to say, the fourth embodiment has the following one feature. Although a program is encrypted for each block and is stored in an external memory, all of the blocks are not encrypted by the same encryption key. In other words, in order to analyze a certain block, it is required to obtain an encryption key of the certain block. As a result, it takes a long time to analyze the certain block.

Also, when one block is executed, the next block to be executed is decrypted. Therefore, a plain text is expanded in an internal memory only for each block. In other words, because there is few plain texts in the memory, it is difficult to analyze the entire program.

Here, a difference between the third embodiment and the fourth embodiment will be described.

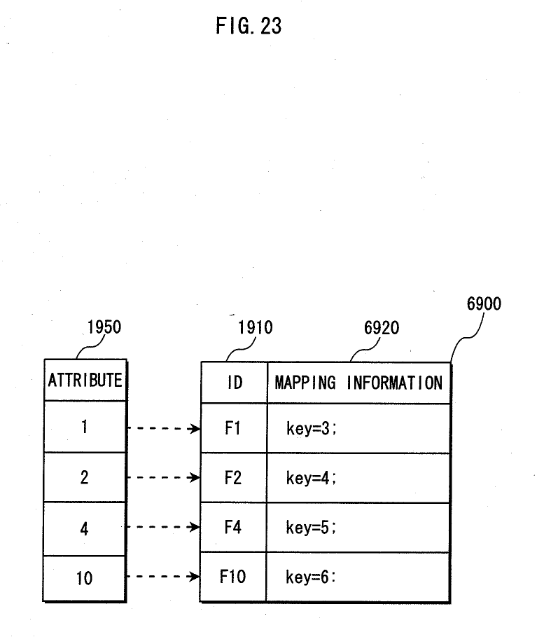

The fourth embodiment is different from the third embodiment in that mapping information is different. FIG. 23 shows a mapping correspondence table 6900 of the fourth embodiment.

The mapping correspondence table 6900 is composed of the ID 1910 and mapping information 6920. The ID 1910 is an identifier of the mapping information 6920 same as in the third embodiment.

In other words, in the mapping correspondence table 5900 of the third embodiment (refer to FIG. 20), it is determined that what kind of operation is performed on a value of a variable according to each attribute. However, in the fourth embodiment, an encryption key for encrypting a block is determined according to each attribute.

### <Structure>

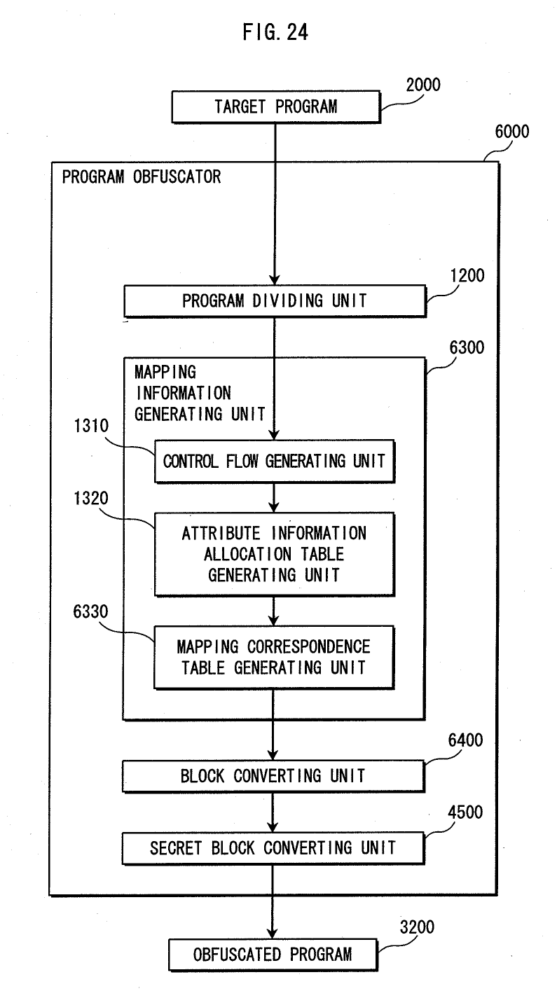

FIG. 24 is a block diagram showing a structure example of a program obfuscator 6000 of the fourth embodiment.

The program obfuscator 6000 has the following two different points from the program obfuscator 5000 (refer to FIG. 21) of the third embodiment.

Firstly, the content of a mapping generated by a mapping correspondence table generating unit 6330 of a mapping information generating unit 6300 is different. Secondly, a method of generating a program instruction group added by a block converting unit 6400 is different because the content of the mapping is different. In addition, the block converting unit 6400 generates an obfuscated program 3200 by performing encryption.

### <Operation>

The following describes processing by the mapping correspondence table generating unit 6330 of the mapping information generating unit 6300 and the block converting unit 6400. Note that other operations are same as in the third embodiment in that the target program is divided into blocks and the entry attribute and the exit attribute are set to each block (refer to FIG. 16 and the like).

### <Processing by the Mapping Correspondence Table Generating Unit 6330 of the Mapping Information Generating Unit 6300>

FIG. 23 shows the mapping correspondence table 6900 of the fourth embodiment.

The mapping correspondence table 6900 is composed of the ID 1910 and the mapping information 6920. The ID 1910 is an identifier of the mapping information 6920 same as in the first embodiment.

The mapping information 6920 indicates a value of an encryption key. For example, the attribute information F1 is “Key=3”.

In the fourth embodiment, a value of a key corresponding to each attribute has been determined in advance. Note that the key may be randomly generated when the mapping correspondence table is generated.

### <Processing by the Block Converting Unit>

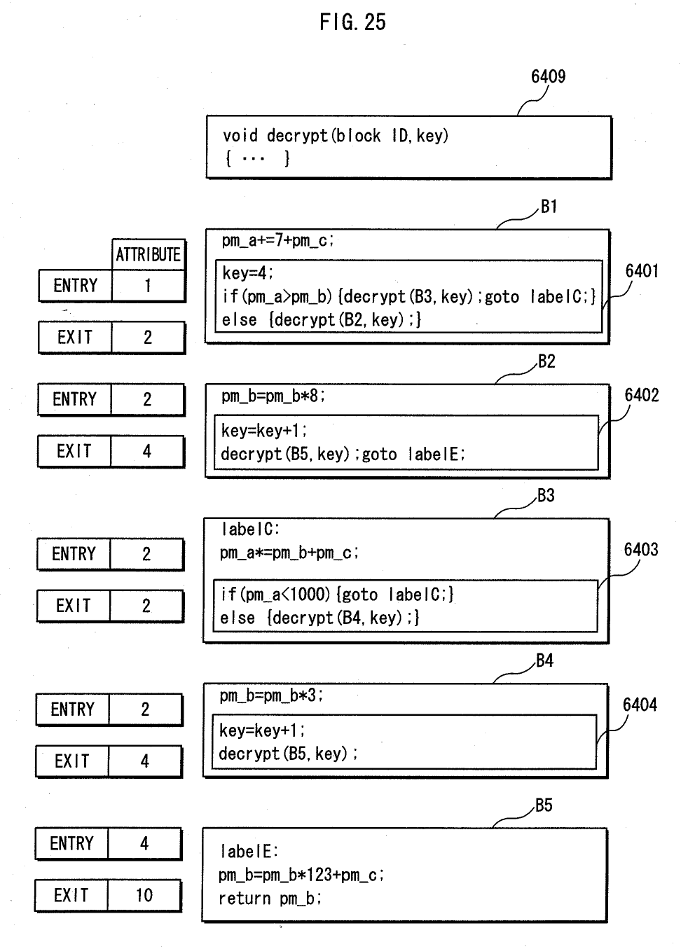

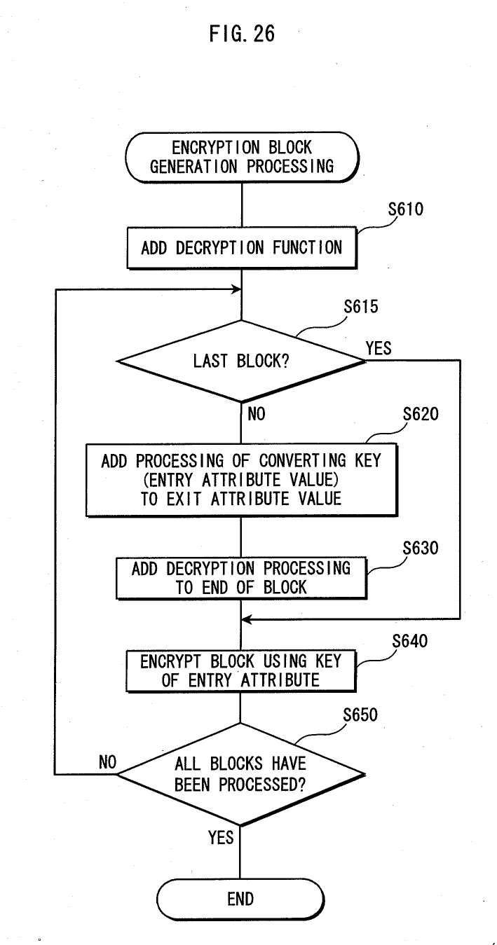

The following describes processing by the block converting unit, with reference to FIGS. 25 and 26.

FIG. 25 shows converted blocks, and FIG. 26 is a flowchart showing the processing by the block converting unit.

The following describes the processing by the block converting unit based on the flowchart shown in FIG. 26, with reference to the blocks shown in FIG. 25.

Firstly, a program of a decryption function “decrypt” is added to a target program (step S610, refer to a decryption program 6409 in FIG. 25).

This decryption function defines “block ID” that is an identifier of a block to be encrypted and an encryption key “key” as arguments, and encrypts a block specified by “block ID” using “key”. Although an identifier of a block is specified here, the present invention is not limited to this and any method of specifying a block may be used. For example, a starting address and an ending address of a block may be specified.

Then, to each of the blocks, a program instruction for decrypting a block to be executed next to the block (hereinafter, referred to as “next block”) is added. The program instruction is each of program instruction groups 6401 to 6404 in FIG. 25. In the fourth embodiment, there is no block to be executed next to the last block B5 (“YES” in step S615). Therefore, the program instruction is not added to the block B5. When a block is not the last block (“NO” in step S615), the following program instruction group for decrypting the next block is added to the block.

In the additional program instruction group, the next block is decrypted using the decryption function. A key of the exit mapping information is set to “key” specified as the decryption function, i.e. a decryption key.

In the first block, a value of the exit mapping information is set to “key” (refer to the first line of the program instruction group 6401 in the block B1). For example, because the exit mapping information of the block B1 that is the first block is “2”, “4” of the mapping information F4 “key=4;” (refer to FIG. 23) is set to “key”.

Also, in each of other blocks, a program instruction for obtaining the exit mapping information from the entry mapping information is added (step S620).

In the bock B2, for example, the entry mapping information is “2”, the exit mapping information is “4” and keys corresponding to the entry mapping information and the exit mapping information are “4” and “5” respectively (refer to FIG. 23). Therefore, “key=key+1;” that is an expression for obtaining “5” from “4” is added to the block B2 (refer to the first line of the program instruction group 6402 in the block B2).

After that, the following program instruction group is added to the original branch instruction. To the program instruction group, a program instruction in which “block ID” and “key” of a block to be executed next are set as arguments of a decryption function is added (step S630).

For example, “decrypt (B5, key);go to labelE;” is added to the block B2 (refer to the second line of the program instruction group 6402 in the block B2). Here, “B5” is a block ID of the block B5.

After that, the block is encrypted using an encryption key indicated by the entry mapping information (step S640).

In the block B2, for example, after the program instruction group 6402 is added, the block B2 is encrypted using the entry mapping information “2”, i.e. “Key=4”.

The processing from the step S620 to the step S640 is performed on all of the blocks (step S650).

In the obfuscated program of the fourth embodiment, only a block being executed is in the memory as a plain text when the obfuscated program is executed. Therefore, it is difficult to recognize the entire target program, and this makes it difficult to analyze the program.

### <Supplement>

Up to now, the program obfuscator of the present invention has been described specifically through the above-described embodiments. However, the technical scope of the present invention is not limited to the above-described embodiments, and the program obfuscator may be partially modified. For example, the following are modifications.

(1) In the above-described embodiments, when there are branches between first and second blocks, and a third block, exit mapping information of each of the first and second blocks is same as entry mapping information of the third block. However, the exit mapping information of the first block may be different from the exit mapping information of the second block.

For example, the following case can be applied to the first embodiment. The exit mapping information of the block B1 is “pm_{—}0=12; pm_{—}1=7;”, the exit mapping information of the block B4 is “pm_{—}0=4; pm_{—}1=13;”, and the entry mapping information of the block B5 are “pm_{—}0=12; pm_{—}1=7;” and “pm_{—}0=4; pm_{—}1=13;”.

In this case, the entry mapping information of the block B5 indicates a mapping for causing (pm_{—}0_before, pm_{—}1_before) satisfying pm_{—}0_beforeεPM_{—}0, pm_{—}1_beforeεPM_{—}1 to correspond to any of (12,7) and (4,13).

In this case, the processing added to the block B5 is a mapping for causing “(pm_{—}0 before, pm_{—}1_before)=(12,7), (4,13)” to correspond to “(pm_{—}0_after, pm_{—}1_after)=(13,21)”. For example, additional program instruction groups “pm_{—}0=(pm_{—}0−12)*(pm_{—}0−4)+13; pm_{—}1=(pm_{—}1−7)*(pm_{—}1−13)+21;” or “pm_{—}0=3*(pm_{—}0−12)*(pm_{—}1−13)+13; pm_{—}1=4*(pm_{—}0−4)*(pm_{—}1−7)+21;” is added.

With the above-stated structure, even if an unauthorized analyst finds the exit mapping of the first block by performing any analysis, the unauthorized analyst cannot find the exit information of the second block. As a result, this can make it difficult to analyze the program.

(2) The additional variable in the first embodiment may be an argument of a program.

When the additional variable is the argument of the program, it is required that a calling source of the function func is also changed.

For example, when the calling source is “func(a,b);” and the initial values of the additional variables are “0” and “1”, the calling source is changed to “func(a,b,0,1);”.

Note that in order to obfuscate the initial values of the additional variables in the program including the calling source, the calling source may be further obfuscated using this obfuscation method.

With the above-mentioned structure, even if an unauthorized analyst locally analyzes the function func, it is difficult for the unauthorized analyst to find the initial values of the additional variables.

(3) In the second and third embodiments, the same variable as in the original program is allocated to the entry mapping information F_IN of the block that is the starting point of the control flow. However, a different variable may be allocated.

For example, the entry mapping information F1 of the block B2 of the second embodiment is “pm_a_after=pm_a_before; pm_b_after=p_b_before; pm_c_after=pm_c_before;”. However, the entry mapping information F1 may be “pm_b_after=pm_a_before; pm_a after=pm_b_before; pm_c after=pm_c_before;”.

When other mapping is used as mentioned above, it is required that the calling source of the function func is also changed.

For example, when the calling source is “func (a,b,c);”, the calling source is changed to “func(b,a,c);” based on the mapping information F1.

Note that in order to obfuscate the program including the calling source, the program of the calling source may be further obfuscated using this obfuscation method.

With the above-mentioned structure, even if an unauthorized analyst locally analyzes the function func, it is difficult for the unauthorized analyst to find the initial values of the additional variables before the replacement.

(4) In the above-described embodiments, the mapping information indicates the mapping for causing pm_X (X=a,b,c) to correspond to pm_X(X=a,b,c). However, the mapping may be a mapping for causing pm_X(X=a,b,c) to correspond to other variable pm_Y(Y=d,e,f) that has a different size.

With the above-mentioned structure, even if the additional program instruction group includes multiplication, an overflow can be prevented.

This can increase a variation of the program instructions composing the additional program instruction group, and make it difficult to judge, in the program instruction group included in the block, which program instruction is the additional program instruction and which program instruction is the program instruction that has been originally included in the block.

For example, in the third embodiment, pm_X (X=a,b,c) is defined as a 16-bit int type variable, pm_Y (Y=d,e,f) is defined as a 32-bit long type variable, and the variable pm_Y (Y=d,e,f) is added to the program.

In this case, for example, the mapping information F2 may be “pm_d_after=(long)pm_a_before*3−4;” and the additional program instruction group G_2_INV may be “pm_a=(pm_d+4)/3;”.

Also, a type itself for storing pm_X (X=a,b,c) may be changed.

For example, in the third embodiment, the variable declaration “f (int pm_a, int pm_b, int pm_c)” may be “f (long pm_a, long pm_b, long pm_c)”, the mapping information F2 may be “pm_a_after=pm_a_before*3−4;”, and the additional program instruction group G_2_INV may be “pm_a=(pm_a+4)/3;”.

(5) In the above-described embodiments, the mapping information indicates the mapping for causing pm_X (X=a,b,c) to correspond to pm_X(X=a,b,c). However, the mapping may be a mapping for causing pm_X(X=a,b,c) to correspond to other variable pm_Y(Y=d,e,f), or a mapping for causing pm_X(X=a,b,c) to correspond to pm_Y(Y=a,b,c,d,e,f) including other variable.

For example, in the third embodiment, a variable “pm_d, pm_e, pm_f” may be added to the program, the mapping information F2 may be “pm_a_after=pm_a_before/3; pm_d_after=pm_a_before %3;”, and the additional program instruction group G_2 INV may be “pm_a=pm_a*3+pm_d;”.

The above-mentioned structure can increase a variation of the program instructions composing the additional program instruction group, and make it difficult to judge, in the program instruction group included in the block, which program instruction is the additional program instruction and which program instruction is the program instruction that has been originally included in the block.

(6) In the third embodiment, as shown by “pm_a_after=pm_a before+14; pm_b_after=pm_b_before+12; pm_c_after=pm_c_before−6;”, the mapping information indicates the mapping for calculating one variable (pm_a_after, for example) using a value of one variable (pm_a_before, for example). However, the mapping may be a mapping for calculating a plurality of variables using a plurality of values of variables.

For example, the mapping information F2 may be “pm_a_after=pm_a before+pm_b_before; pm_b_after=pm_a_before−pm_b_before”, and the additional program instruction group G_2_INV may be “tmp=pm_a; pm_a=(pm_a+pm_b)/2; pm_b=(tmp−pm_b)/2;”.

The above-mentioned structure can increase a variation of replacement of the roles of the variables, and make it difficult to analyze the program.

(7) In the above-described embodiments, the mapping information is randomly generated. However, the mapping information may be generated based on the program instructions included in the block.

For example, in the first embodiment, the block B5 includes the secret information “123”.

In this case, the value of “pm_{—}0_after” in the exit mapping information of the block B5 may be a value of the secret information, and the exit mapping information may be “pm_{—}0_after=123; pm_{—}1_after=31;”.

In this case, if the block converting unit 1400 converts “pm_b=pm_b*123+pm_c;” to “pm_b=pm_b*pm_{—}0+pm_c;”, the program can be obfuscated so as to obtain a proper processing result.

With the above-mentioned structure, it is not required to perform the processing of calculating the value used in the program based on the randomly generated mapping information. Therefore, this can decrease an increase of size of an obfuscated program and an increase of an execution time caused by converting the processing of calculating the secret information.

(8) In the first embodiment, the number of the additional variables is two. However, the number of the additional variables is not limited to two.

When the number of the additional variables decreases, the size of the obfuscated program can be small and an execution speed can be accelerated, and when the number of the additional variables increases, a greater effect of the obfuscation can be obtained.

(9) In the second and third embodiments, the number of variables for replacing the variables is three. However, the number of variables for replacing the variables is not limited to three.

Also, a user, an external device, a calling source program, or the like can specify which variable is replaced.

(10) In the third embodiment, an example of a mapping is shown. However, other mapping having an inverse mapping can be also applied.

Also, the inverse mapping is generated from the mapping each time the inverse mapping is required. However, a column in which the inverse mapping is written may be provided in the mapping correspondence table 5900 generated by the mapping correspondence table generating unit 5330.

With the above-mentioned structure, if the inverse mapping is generated once, it is not required to generate the same inverse mapping after that. Therefore, the obfuscation processing can be speeded up.

Also, a program instruction group F_X added corresponding to the mapping information F_X and a program instruction group F_X_INV added corresponding to F_X_INV that is the inverse mapping of the mapping information F_X may be written in the mapping correspondence table.

This structure can save trouble of generating the same program instruction group more than once for the same mapping information and the inverse mapping information. Therefore, the obfuscation processing can be speeded up.

Also, a user can specify the above-mentioned mapping, inverse mapping, additional program instruction group F_X, and the additional program instruction group F_X_INV.

(11) In the above-described embodiments, the target program is composed of C language. However, the target program may be composed of other program languages such as Java (registered trademark) language, Java (registered trademark) byte code, C++ language, machine language, assembly language, intermediate language such as compiler, modeling language such as UML (Unified Modeling Language), and the like.

Also, the target program may be design data of a logic circuit written by logic circuit description language or the like.

Moreover, in the above-described embodiments, the obfuscation target program composed of C language is obfuscated to generate the obfuscated program composed of C language. However, the obfuscated program may be outputted as machine language.

Furthermore, the obfuscation target program may have a structure written by the UML not the C language, and the obfuscated program may be composed of the Java (registered trademark) language and the like.

(12) In the above-described embodiments, a set PM_X in which the values that can be taken by the variable “pm_X” are the elements may be determined according to a type of the variable, and may be specified by a user in advance.
(13) In the above-described embodiments, the program instruction group is added to the beginning of the block. However, the program instruction group may be added to other place.

For example, in the processing by the block converting unit 5400 in the second embodiment, the additional program instruction group G_2_4 “tmp=pm_a; pm_a=pm_c; pm_c=pm_b; pm_b=tmp;” may be added after the program instruction included in the block B2 “pm_b=pm_b*8;”.

In this case, with regard to the program instruction before the additional program instruction group, the variables are replaced based on the entry mapping information of the block B2, and with regard to the program instruction after the additional program instruction group, the variables are replaced based on the exit mapping information of the block B2.

Here, in “pm_b=pm_b*8;”, the variable is replaced based on the entry mapping information F2 of the block B2 to obtain “pm_c=pm_c*8;”.

With the above-mentioned structure, the places including the additional program instruction group are different for each of the blocks. This can make it difficult to analyze which program instruction is the additional program instruction, and which program instruction is the program instruction that is originally included in the block, based on the converted block.

In the same manner as this, the program instruction that has been included in the block may be in the middle of the additional program instruction group. This can make it more difficult to analyze which program instruction group has been included in the block.

(14) In the first embodiment, the secret block converting unit 1500 replaces the secret information. In the replacement, the secret block converting unit 1500 may replace secret information specified by a user, or may replace all constant values included in the program.

Also, the constant values included in the program may be replaced at a certain rate, or randomly selected values may be replaced.

With the above-mentioned structure, the obfuscation can be performed at a speed faster than the case where all pieces of secret information are replaced. Also, the number of processing increased because of the obfuscation can be suppressed. Therefore, an operation of the obfuscated program can be performed at a high speed.

(15) In the first embodiment, an example of the additional program instruction group G_1_2 is shown. However, the program instruction group is not limited to the additional program instruction group G_1_2, and may be a program instruction group for realizing a mapping for causing (0,1) to correspond to (30,6). The same applies to a program instruction group for realizing other mapping.

Also, the method of generating the additional program instruction group is not limited to the method described in the above-described embodiments, and may be other method.

That is to say, if a program instruction group is generated so that a conversion according to the exit mapping information is performed when the entry mapping information is given, any method can be applied.

(16) In the first embodiment, the mapping information indicates the mapping for causing all (pm_{—}0_before, pm_{—}1_before) satisfying pm_{—}0_beforeεPM_{—}0, pm_{—}1_beforeεPM_{—}1 to correspond to one point ((0,1), for example). However, the mapping may be a mapping for causing all (pm_{—}0_before, pm_{—}1_before) to correspond to a plurality of points.

For example, the mapping information F2 may be a mapping for causing (pm_{—}0_before, pm_{—}1_before) to correspond to any of (1,2) and (4,5), and the mapping information F4 may be a mapping for causing (pm_{—}0 before, pm_{—}1_before) to correspond to any of (5,6) and (8,9). Also, the additional program instruction group G_2_4 may be a program instruction group for realizing a mapping for causing (1,2) to correspond to (5,6) and (4,5) to correspond to (8,9).

In this case, the additional program instruction group G_2_4 is, for example, “pm_{—}0=pm_{—}0+4; pm_{—}1=pm_{—}1+4;”.

Also, the additional program instruction group may include a variable other than the additional variables.

For example, the mapping information F2 may be a mapping for causing (pm_{—}0_before, pm_{—}1_before) to correspond to any of (0,1) and (3,4), and the mapping information F4 may be a mapping for causing (pm_{—}0_before, pm_{—}1_before) to correspond to any of (0,1) and (1,2). Also, the additional program instruction group G_2_4 may be, for example, “pm_{—}0=pm_{—}0%3+pm_a %2; pm_{—}1%3+pm_a %2;”.

As mentioned above, a set may be used instead of causing the values of the specific variables to correspond to a plurality of points using the mapping information.

For example, the mapping information F2 may be a set for causing (pm_{—}0_before, pm_{—}1_before) to correspond to (multiple of six, value leaving a reminder of 1 when divided by 3), the mapping information F4 may be a set for causing (pm_{—}0_before, pm_{—}1_before) to correspond to (value leaving a reminder of 1 when divided by 6, value leaving a reminder of 2 when divided by 3). Also, the additional program instruction group G_2_4 may be, for example, “pm_{—}0=pm_{—}0+1; pm_{—}1=(pm_{—}1−1)*2+2;”.

With the above-mentioned structure, the values of the additional variables after executing the additional program instruction group are changed according to a value of the variable other than the additional variables. Therefore, this makes it difficult for an unauthorized analyst to analyze which variable is the additional variable and which variable is a variable that has been originally included in the program.

The following specifically describes this effect. When the variable other than the additional variables is not used, the unauthorized analyst can specify the values of the additional variables of the mapping information by the following method. In order to analyze the exit mapping information and the entry mapping information of the block, the unauthorized analyst changes a value of an argument of a function, executes the function func more than once, collects values (run-time data) in the memory when the function func is executed, calculates a difference between the values, and extracts constant data.

On the other hand, with the above-mentioned structure, the values of pm_{—}0, pm_{—}1 obtained after executing the additional program instruction group are not fixed values. Therefore, this makes it difficult to analyze the mapping information. This also makes it difficult to analyze which variable stores the mapping information.

Note that the unauthorized analysis for collecting the run-time data is described in “Tamper Resistance Evaluation of Signature Generation Software by Searching Run-time Data SCIS2005”.

Note that the variable other than the additional variable is not necessarily included in the obfuscation target program. For example, the variable may be a value held in a ROM, a RAM, a register, a cache, or the like.

(17) In the processing by the secret block converting unit 1500 in the first embodiment, the secret information to be replaced may be a numerical value indicating a branch destination of a block such as an address of the branch destination of the program.

For example, in the processing by the secret block converting unit 1500 in the first embodiment, an unconditional branch instruction of the block B2 “goto labelE;” is replaced with a conditional branch instruction “switch (2) {case 1:goto labelC; case 2 goto labelE:}”.

In this conditional branch instruction, the labels “labelE:” and “labelC:” included in the obfuscation target program are conditional branch destinations. Also, the conditional expression is a value “2” of the case sentence corresponding to the original unconditional branch destination “label E;”.

Then, the conditional expression “2” is replaced with a program instruction using the additional variables based on the ext mapping information of the block B2, by using the method described in the processing by the secret block converting unit 1500.

Moreover, in the first embodiment, the secret information is replaced with the expression. However, instead of the replacement, the program instruction may be added.

In the first embodiment, for example, “pm_b=pm_b*123+pm_c;” is replaced with “pm_b=pm_b*(3*pm_{—}0+4*pm_{—}1−40)+pm_c;” (refer to FIGS. 13 and 14). However, one program instruction may be added instead of the replacement.

More specifically, “pm_{—}0” is the exit attribute “10” of the block B5, and “pm_{—}0=13”. Therefore, “pm_b=pm_b*pm_{—}0/13;” is added to obtain “pm_b=pm_b*pm_{—}0/13; pm_b=pm_b*123+pm_c;”.

This structure can make it difficult to analyze the execution order of the program.

(18) It is not required that the units are necessarily independent of each other. The functions included in the plurality of units may be combined to generate one unit.
(19) The first embodiment includes the variable adding unit for adding the variables to the obfuscation target program. However, a variable that is not used in the obfuscation target program may be used instead of the additional variables.
(20) In the above-described embodiments, in the processing by the block converting unit, it may be not required to add the additional program instructions to the block having the same entry mapping information and the exit mapping information.

This structure can reduce the size of the obfuscated program and shorten the execution time.

Also, in the attribute information allocation table 1800, different attributes may be replaced with a same attribute. For example, in the columns of the attribute 1831 of the attribute information allocation table 1800 used in the above-described embodiments, “4” may be replaced with “2” (refer to FIG. 9). This corresponds to the exit attribute of the block B2, the exit attribute of the block B4, and the entry attribute of the block B5.

This structure can increase the number of blocks whose entry mapping information is same as the exit mapping information. Further, this can reduce the size of the obfuscated program and shorten the execution time.

(21) The present invention may have a structure in which the first embodiment is combined with the third embodiment.

This structure can make it difficult to analyze which variable is the additional variable and which variable has been included in the program.

Also, the present invention may have a structure in which the first, second, and fourth embodiments, and the modifications (such as the supplement (1) and the like) are combined with each other.

(22) In the above-described embodiments, the obfuscation target program is divided into the basic blocks. However, other division method may be applied to the present invention.

For example, the basic blocks may be further divided into a plurality of blocks. When the basic block is “a=1;a=a*2;a−3;”, each program instruction is defined as a block, i.e. each of “a=1;”, “a=a*2;”, and “a−3;” is a block. In this case, it is regarded that there is a branch between a block “a=1;” and a block “a=a*2;”, and a control flow is generated. This structure can add the additional program instruction group in a smaller unit than the basic block. Therefore, this can make it more difficult to analyze the program.

Also, a block may be generated independently from the basic block.

In this case, the additional program instruction is added after the last meeting point in the block and before the first branch point. If there is no program instruction group after the last meeting point in the block and before the first branch point, the entry mapping information and the exit mapping information of the block are same.

Note that the branch point is a location including the branch instruction (the conditional branch instruction and the unconditional branch instruction), and the meeting point is a location of a branch destination at which the execution route branches according to the branch instruction.

(23) In the processing by the block converting unit 1400 in the embodiments, the function is added to the block by adding the program instruction. However, the present invention is not necessarily limited to this structure.

For example, a program instruction group 1 composed of some of program instructions in the block is deleted, and a program instruction group for performing processing of both the program instruction group 1 and the additional function may be added.

In the second embodiment, for example, the program instruction “pm_b=pm_b*8;” is deleted from the block B2, and the program instruction group D “tmp=pm_a; pm_a=pm_c*8; pm_c=pm_b; pm_b=tmp;” may be added.

Here, the program instruction group D is obtained by replacing the second program instruction “pm_a=pm_c;” and the fifth program instruction “pm_a=pm_a*8;” in the program instruction group of the converted block B2 “tmp=pm_a; pm_a=pm_c; pm_c=pm_b; pm_b=tmp; pm_a=pm_a*8;” (refer to FIG. 17) with processing for performing both the second program instruction and the fifth program instruction at the same time.

(24) In the above-described embodiments, the replacement of the variables based on the mapping information is taken as an example. However, the present invention is not limited to this example.

In the above-described embodiments, each block is obfuscated by the following method. With regard to the variable for calculating the secret information passed between the blocks, a value at an exit of a block is same as a value at an entry of a next block, and a value when outputted from the block is in a range of a value expected as an input of the next block. However, the present invention may include an obfuscation conversion having the same feature.

For example, as in the fourth embodiment, the block that is the branch destination may be encrypted and the processing of decrypting the block is added to a block that is the branch source.

Also, a conversion for falsifying an instruction in a block is performed on the block that is the branch destination, and the processing for releasing the falsification may be added to the block that is the branch source.

That is to say, the present invention can perform the obfuscation regardless of a control structure of a program by performing the obfuscation having a characteristic cancelled by the block that is the branch destination and the block that is the branch source.

(25) More specifically, each of the devices is a computer system composed of a microprocessor, a ROM, a RAM, a hard disk unit, a display unit, a keyboard, and a mouse. A computer program is stored in the RAM or the hard disk unit. Each of the devices fulfills a function thereof by the microprocessor operating in accordance with the computer program. Here, the computer program is composed of a plurality of instruction codes indicating an instruction to a computer in order to fulfill the predetermined function.
(26) A part or all of the component parts that construct each device of the present invention may be constructed by one system LSI (Large Scale Integration). The system LSI is a highly functional LSI that is manufactured by accumulating a plurality of component parts on one chip. More specifically, the system LSI is a computer system including a microprocessor, a ROM, a RAM, or the like. A computer program is stored in the RAM. Because the microprocessor operates in accordance with the computer program, the system LSI achieves a function thereof.
(27) A part or all of the component parts that construct each device of the present invention may be constructed by an IC card which is removable from each device or a single module. The IC card or the module is a computer system including a microprocessor, a ROM, a RAM, or the like. The IC card or the module may include the highly functional LSI. Because the microprocessor operates in accordance with the computer program, the IC cardor the module fulfills a function thereof. The IC card or the module may have a tamper resistant.
(28) The present invention may be realized by methods described in the above-mentioned embodiments. Also, the present invention may be realized by a computer program executed on a computer for realizing these methods, or by a digital signal representing the computer program.
(29) Also, the present invention may be realized by a computer-readable recording medium on which the computer program or the digital signal is recorded. Examples of the computer-readable recording medium include a flexible disk, a hard disk, a CD-ROM, an MO, a DVD, a DVD-ROM, a DVD-RAM, BD (Blu-ray Disc), and a semiconductor memory. Also, the present invention may be realized by the digital signal recorded on such recording media.
(30) Further, the present invention may be realized by the computer program or the digital signal transmitted via an electric communication line, a wired/wireless communication line, a network such as the Internet, or data broadcast.
(31) Moreover, the present invention may be realized by a computer system including a microprocessor and a memory. The memory may store the computer program, and the microprocessor may operate in accordance with the computer program.
(32) The computer program or the digital signal may be transferred as being recorded on the recording medium, or via the network or the like, so that the computer program or the digital signal may be executed by another independent computer system.

### <Details and Problems of Conventional Technology>

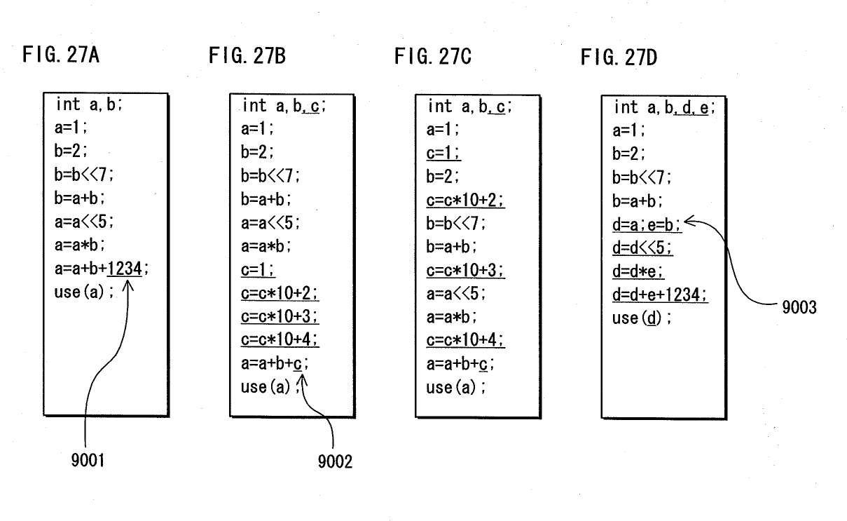

FIG. 27 is a program example showing a conventional obfuscation method.

### <Original Program>

An original program before obfuscation is shown in FIG. 27A. In this program, “1234” is secret information 9001 that should not be known by an unauthorized analyst. Note that the following basically describes an example of a program written by C language, unless an advance notice is given.

In the program before obfuscation shown in FIG. 27A, a value of the secret information 9001 can be narrowed by collecting all constants included in this program. In other words, when the constants included in FIG. 27A are collected, “1”, “2”, “7”, “5”, and “1234” are obtained, and one of the obtained constants is the value of the secret information. Therefore, an unauthorized analyst can narrow the value of the secret information down to five values only by collecting the constants included in the program.

<Program after Replacing the Secret Information>

FIG. 27B shows a program in which the secret information included in the program is converted so as to be calculated by executing a plurality of program instructions.

This program is generated by adding a new variable “c” to the original program shown in FIG. 27A, adding a program instruction for calculating the secret information “1234” using the added variable “c”, and replacing the secret information “1234” with “c (9002)”.

In FIG. 27B, “c=1;c=c*10+2;c=c*10+3;c=c*10+4;” is a program instruction group for calculating the secret information “1234”.

In the program shown in FIG. 27B, the secret information “1234” cannot be directly obtained even if all of the constants included in the program are collected.

Therefore, this program is safer than the program shown in FIG. 27A.

However, if an unauthorized analyst analyzes the program instruction itself of the program and judges that “c” in “a=a+b+c;” is the secret information 9001, the unauthorized analyst can analyze the value of the secret information “1234” because of the following reason. If the unauthorized analyst sequentially executes the program instructions for calculating the secret information “c=1;”, “c=c*10+2;”, “c=c*10+3;”, and “c=c*10+4;”, the unauthorized analyst can analyze that values of “c” (9002) are “1”, “12”, “123”, and “1234” in sequence.

<Program after Diffusing the Secret Information>

Next, FIG. 27C shows a program in which program instructions for calculating the secret information are diffused in various places in the program. This program is generated by diffusing the program instructions “c=1;”, “c=c*10+2;”, “c=c*10+3;”, and “c=c*10+4;” for calculating the secret information included in the program after replacing the secret information shown in FIG. 27B, in various places in the program.

In the program after replacing the secret information shown in FIG. 27B, the program instructions for calculating the secret information are in one place. On the other hand, in FIG. 27C, the program instructions are diffused in the various places. Therefore, it becomes difficult to find the program instructions for calculating the secret information.

Also, in addition to the above-mentioned obfuscation method, the non-patent document 1 discloses that it becomes difficult to analyze a program by changing a memory for variables storing values in the process of calculation several times while the program is executed. As an example of such obfuscation, FIG. 27D shows a program in which roles of variables are replaced in the middle of the program.

<Program in which Roles of Variables are Replaced in the Middle of the Program>

FIG. 27D shows a program in which roles of variables are replaced in the middle of the program. This program is generated by adding variables “d” and “e” to the original program shown in FIG. 27A, adding “d=a;b=e;” in the middle of the program, and replacing the variables “a” and “b” with “d” and “e” respectively located after the location to which “d=a;b=e;” is added.

That is to say, this program is generated by adding “d=a;b=e;” (a program instruction 9003) in the middle of the original program, replacing the variables “a” and “b” with “d” and “e” in the program instruction group located after the location to which “d=a;b=e;” is added, and replacing “a=a<<5;a=a*b;a=a+b+1234;use(a)” with “d=d<<5;d=d*e;d=d+e+1234;use(d)”.

In this program, the roles of the variables “a” and “b” are performed by the variables “d” and “e” after the middle of the program. Therefore, this can make it difficult to find the variable used for calculating the secret information.

### <Problem>

There is a method of making it difficult to analyze a program by converting secret information included in the program so as to be calculated by executing a plurality of program instructions, and diffusing the program instructions in the various places in the program. However, it is difficult to diffuse the program instructions in a program having a complicated control structure. Therefore, this case causes a problem that an unauthorized analyst can relatively easily obtain the secret information by intensively analyzing a specific place in the program. The following specifically describes this problem.

### (a) Original Program

FIG. 28 shows an original program before obfuscation. The original program includes a function func, and the function is composed of a program instruction group 9110. Note that “123” is the secret information (refer to a program instruction 9101).

FIG. 29 shows a control flow of the original program.

The control flow indicates a flow of control such as a branch and a confluence using a graph, and is generally called a control flow graph. The generation of the control flow is composed of, for example, a basic block generating step and a graph generating step as mentioned below.

The basic block generating step generates a basic block from an obfuscation target program. The basic block is a program instruction group composed of one or more program instructions. Also, the basic block is a program instruction group in which the execution control is transferred from another block only to a first instruction of the basic block and to another block from a last instruction of the basic block.

More specifically, the basic block is the following program instruction group. Anyone of (i) a program instruction at an entry of a program (a program instruction initially executed in the program), (ii) a program instruction at which the execution route meets, and (iii) a program instruction next to a branch instruction, is defined as a starting program instruction. Then, any one of (i) a program instruction immediately before a program instruction at which the execution route meets, (ii) a program instruction at an exit of the program (a program instruction lastly executed in the program), and (iii) a branch instruction, is defined as an ending program instruction. The basic block is a program instruction group composed of program instructions between the starting program instruction and the ending program instruction.

The basic block generating step divides the obfuscation target program into a plurality of basic blocks so that all of the program instructions composing the obfuscation target program are included in any one of the basic blocks.

The graph generating step performs the following processing.

When each of the basic blocks is regarded as a node, (i) if a first node includes a branch instruction to a second node (unconditional branch instruction by goto sentence, break sentence, continue sentence, and return sentence, or conditional branch instruction by for sentence, while sentence, do-while sentence, if sentence, and switch sentence), or (ii) if the last program instruction in the first node is other than the unconditional branch instruction and a program instruction immediately after the last program instruction is in the second node, it is regarded that there is an edge between the first node and the second node. Then, a graph composed of nodes and edges is generated.

In FIG. 29, the blocks 9111 to 9115 are generated by dividing a program into a plurality of program instruction groups. Each of the blocks is a program instruction group composed of one or more program instructions. Also, each arrow indicates a flow of control and an edge.

The two arrows from the block 9111 indicate that any of the blocks 9112 and 9113 is executed after the block 9111 is executed without forcibly changing an execution procedure of the program using a debugger, i.e. in a normal system. The block 9115 includes a value “123” that is the secret information.

(b) Control Flow of a Program after Replacing the Secret Information

FIG. 30 shows a control flow of a program generated by adding a new variable “c” to the original program shown in FIG. 27A, adding a program instruction for calculating the secret information “123” using the added variable “c”, and replacing the secret information “123” with “c” same as in FIG. 27B.

In other words, “c=1;” and the variable “c” are initialized in the block 9211, and “c=c*10+2;c=c*10+3;” is calculated in the block 9215 so that the variable “c” is the value “123” as a result of the calculation.

(c) Control Flow of the Program after Diffusing the Secret Information

FIG. 31 shows a program in which the program instructions for calculating the secret information shown in FIG. 30 are diffused in various place of the program.

The following describes a procedure of generating the control flow shown in FIG. 31 based on the program shown in FIG. 30.

Firstly, a block to which the program instruction “c=c*10+2;” included in the block 9215 is moved is determined (refer to FIG. 30).

Here, this program instruction cannot move to one side of a conditional branch because of the following reason. When this program instruction is moved to the block 9114, for example, if the execution route branches to the block 9112 without executing the block 9114, this program instruction “c=c*10+2;” is not executed. In this case, the value of “c” in the block 9215 is not “123”. Therefore, a proper operation cannot be performed.

Similarly, this program instruction cannot be included in a loop because of the following reason. If this program instruction is moved to the block 9113, for example, the number of times of executing the program instruction “c=c*10+2;” varies depending on the number of times of executing the block 9113. In this case, if “c=c*10+2;” is executed more than once, the value of “c” in the block 9215 is different from “123”. Therefore, a proper operation cannot be performed.

Therefore, in this program example, in order to assure that the value of “c” is finally “123”, this program instruction “c=c*10+2;” is moved to the block 9311 (refer to FIG. 31). In the same manner as this, the program instruction “c=c*10+3;” is moved to the block 9311. As a result, the program having the control flow shown in FIG. 31 is generated.

As mentioned above, in the conventional method, the program including branches and loops does not have many places to which program instructions can move. As a result, the program instructions are not fully diffused and are concentrated in a specific place. Therefore, the conventional method has a problem that the program instruction group for calculating the secret information can be relatively easily found by intensively analyzing a place other than a place in which it is difficult to diffuse the program instructions (such as branches and loops).

Moreover, the non-patent document 1 discloses that it becomes difficult to analyze a program by changing a memory for variables storing values in the process of calculation.

However, when this method is used for the program having the complicated control structure, the same problem as mentioned above also arises. The following specifically describes the problem.

Suppose that the original program before obfuscation is the program shown in FIG. 28. Also, the control flow of the program is the control flow shown in FIG. 29. The roles of the variables are replaced in the middle of the program.

The replacement of the variables cannot be performed on one side of the branch.

For example, when an instruction for replacing the roles of the variables “d=a;e=b;” is added to the end of the block 9114, “a” and “b” must be replaced with “d” and “e” respectively in the program instruction group “labelE:b*=a*123; return b;” included in the block 9115 to obtain “labelE:;e*=d*123;return e;”.

However, if such replacement is performed, when the block 9115 is executed without executing the block 9114, i.e. when the execution route branches to the block 9112 after the block 9111 is executed, the block 9115 is executed without executing “d=a;e=b;”.

In this case, the values of “d” and “e” are different from the values of “a” and “b”. As a result, a correct operation result cannot be obtained. Therefore, the replacement is prevented from being performed on one side of a branch same as when the program instructions are diffused, and the program instruction for replacing the roles of the variables is added to the block 9111. Thus, even if trying to add many program instructions for replacing the roles of the variables, such program instructions are concentrated on the block 9111. As a result, it becomes easier to find the program instructions.

As mentioned above, even if the program instructions included in the program are converted so as to be complicated using the conventional obfuscation method, it is difficult to obfuscate a program in the case of the program having the complicated control structure.

### INDUSTRIAL APPLICABILITY

The present invention can obfuscate a program so as to be more difficult to be analyzed than the conventional technology. Therefore, the present invention is useful in a field of an obfuscator of a program using secret information such as an encryption key.

1. A program obfuscator for generating an obfuscated program from a target program composed of a plurality of blocks, wherein
each of the blocks is composed of a sequence of instructions,
execution control for the block is (a) transferred from a previously executed block only to a first instruction of the block, and (b) transferred only from a last instruction of the block to a next executed block, and
the program obfuscator comprises:
an attribute determining unit operable to determine an attribute for an entry and an attribute for an exit of each of one or more of the blocks so that an exit attribute of one of the blocks is same as an entry attribute of a next block to which the execution control is transferred from the one of the blocks; and
a generating unit operable to generate the obfuscated program by adding one or more instructions to the one or more of the blocks, the one or more instructions being created according to the entry attribute or the exit attribute of each of the one or more of the blocks.

2. The program obfuscator of claim 1, wherein
the target program includes secret information,
the program obfuscator further comprises:
a block specifying unit operable to specify one of the blocks as a secret block, the specified block including an instruction to obtain the secret information using one or more values of one or more specific variable,
each attribute is associated with the one or more specific variables and the one or more values to be taken by each of the specific variables, and
the generating unit generates the obfuscated program by adding one or more instructions to each block from which the execution control is transferred to the secret block, the one or more instructions causing the specific variable to take one of the values associating with exit attribute of the block.

3. The program obfuscator of claim 2, wherein
when the execution control is transferred to the secret block from two or more of the blocks, the generating unit generates the obfuscated program by adding one or more instructions to each of the two or more of the blocks, the one or more instructions causing the specific variable to take one of the values associating with an exit attribute of each of the two or more of the blocks.

4. The program obfuscator of claim 2, wherein
the generating unit generates the obfuscated program by adding one or more instructions to each block to be executed before the secret block, the one or more instructions causing the specific variable to change from one of the values associating with an entry attribute of the block to one of the values associating with an exit attribute of the block.

5. The program obfuscator of claim 2, further comprising:
a variable adding unit operable to add, to the target program, a variable that is not included in the target program, wherein
the specific variable is the variable added by the variable adding unit.

6. The program obfuscator of claim 2, wherein
at least one of an entry attribute and an exit attribute of each of the blocks is associated with a plurality of values to be taken by the specific variable, and
the generating unit generates the obfuscated program by adding one or more instructions to one of the blocks, the one or more instructions changing the specific variable from one of the plurality of values associating with an entry attribute of the block to one of the plurality of values associating with an exit attribute of the block.

7. The program obfuscator of claim 2, wherein
at least one of an entry attribute and an exit attribute of each of the blocks is associated with a plurality of specific variables, and
the generating unit generates the obfuscated program by (i) adding an instruction to the one of the blocks to replace a value of one of the specific variables with a value of another specific variable according to the exit attribute of the one of the blocks and (ii) adding an instruction to the next block to replace the value of the specific variable with the value of the another specific variable according to the entry attribute of the next block.

8. The program obfuscator of claim 2, wherein
each attribute is associated with a predetermined operation, and
the generating unit generates the obfuscated program by (i) performing a predetermined operation associating with the exit attribute of the one of the blocks on a value of the specific variable to obtain a first result value, and adding an instruction to the one of the blocks to assign the first result value to a value of the specific variable and (ii) performing an inverse operation of the predetermined operation on the value of the specific variable to obtain a second result value, the inverse operation associating with the entry attribute of the next block, and adding an instruction to the next block to assign the second result value to the value of the specific variable.

9. The program obfuscator of claim 1, wherein
each attribute is associated with a replacement relation of a plurality of values of specific variables, and
the generating unit generates the obfuscated program by (i) adding an instruction to the one of the blocks to replace a value of one of the specific variables with a value of another specific variable according to the exit attribute of the one of the blocks and (ii) adding an instruction to the next block to replace the value of the specific variable with the value of the another specific variable according to the entry attribute of the next block.

10. The program obfuscator of claim 1, wherein
each attribute is associated with a specific variable and a predetermined operation, and
the generating unit generates the obfuscated program by (i) performing a predetermined operation associating with the exit attribute of the one of the blocks on a value of the specific variable to obtain a first result value, and adding an instruction to the one of the blocks to assign the first result value to a value of the specific variable and (ii) performing an inverse operation of the predetermined operation on the value of the specific variable to obtain a second result value, the inverse operation associating with the entry attribute of the next block, and adding an instruction to the next block to assign the second result value to the value of the specific variable.

11. The program obfuscator of claim 1, further comprising:
an encrypting unit operable to encrypt the blocks, wherein
each attribute is associated with an encryption key, and
the generating unit generates the obfuscated program by (i) adding one or more instructions to the one of the blocks, the one or more instructions performing processing of decrypting the next block using an encryption key associating with the exit attribute of the one of the blocks and (ii) causing the encrypting unit to encrypt the one of the blocks using an encryption key associating with an entry attribute of the one of the blocks.

12. A program obfuscator for generating an obfuscated program from a target program composed of a plurality of blocks, wherein
each of the blocks is composed of a sequence of instructions, and
the program obfuscator comprises:
an attribute determining unit operable to determine an attribute for an entry and an attribute for an exit of each of one or more of the blocks so that an exit attribute of one of the blocks is same as an entry attribute of a next block to which execution control is transferred from the one of the blocks; and
a generating unit operable to generate the obfuscated program by adding one or more instructions to an execution route of each of one or more of the blocks, the one or more instructions being created according to the entry attribute or the exit attribute of each of the one or more of the blocks, and the execution control passing through the execution route from each entry.

13. A program obfuscator for generating an obfuscated program from a target program composed of a plurality of blocks, wherein
each of the blocks is composed of a sequence of instructions,
execution control for the block is (a) transferred from a previously executed block only to a first instruction of the block, and (b) transferred only from a last instruction of the block to a next executed block, and
the program obfuscator comprises:
an attribute determining unit operable to determine an attribute for an entry and an attribute for an exit of each of the blocks; and
a generating unit operable to generate the obfuscated program by adding one or more instructions to one or more of the blocks, the one or more instructions being created according to the entry attribute or the exit attribute of each of the one or more of the blocks, wherein
each attribute is associated with one or more specific variables and one or more values to be taken by each of the specific variables,
an entry attribute of each block to which the execution control is transferred from two or more of the blocks is associated with a value associating with an exit attribute of each of two or more of the blocks, and
the generating unit generates the obfuscated program by adding one or more instructions to one or more of the blocks, the one or more instructions changing the specific variable from one of the one or more values associating with an entry attribute of each of the one or more of the blocks to one of the one or more values associating with an exit attribute of each of the one or more of the blocks.

14. An obfuscation method used in a program obfuscator for generating an obfuscated program from a target program composed of a plurality of blocks, wherein
each of the blocks is composed of a sequence of instructions,
execution control for the block is (a) transferred from a previously executed block only to a first instruction of the block, and (b) transferred only from a last instruction of the block to a next executed block, and
the program obfuscator comprises:
an attribute determining step of determining an attribute for an entry and an attribute for an exit of each of one or more of the blocks so that an exit attribute of one of the blocks is same as an entry attribute of a next block to which the execution control is transferred from the one of the blocks; and
a generating step of generating the obfuscated program by adding one or more instructions to the one or more of the blocks, the one or more instructions being created according to the entry attribute or the exit attribute of each of the one or more of the blocks.

15. A computer program for causing a program obfuscator to perform obfuscation processing, the program obfuscator generating an obfuscated program from a target program composed of a plurality of blocks, wherein
each of the blocks is composed of a sequence of instructions,
execution control for the block is (a) transferred from a previously executed block only to a first instruction of the block, and (b) transferred only from a last instruction of the block to a next executed block, and
the program obfuscator comprises:
an attribute determining step of determining an attribute for an entry and an attribute for an exit of each of one or more of the blocks so that an exit attribute of one of the blocks is same as an entry attribute of a next block to which the execution control is transferred from the one of the blocks; and
a generating step of generating the obfuscated program by adding one or more instructions to the one or more of the blocks, the one or more instructions being created according to the entry attribute or the exit attribute of each of the one or more of the blocks.

16. An integrated circuit used in a program obfuscator for generating an obfuscated program from a target program composed of a plurality of blocks, wherein
each of the blocks is composed of a sequence of instructions,
execution control for the block is (a) transferred from a previously executed block only to a first instruction of the block, and (b) transferred only from a last instruction of the block to a next executed block, and
the program obfuscator comprises:
an attribute determining unit operable to determine an attribute for an entry and an attribute for an exit of each of one or more of the blocks so that an exit attribute of one of the blocks is same as an entry attribute of a next block to which the execution control is transferred from the one of the blocks; and
a generating unit operable to generate the obfuscated program by adding one or more instructions to the one or more of the blocks, the one or more instructions being created according to the entry attribute or the exit attribute of each of the one or more of the blocks.
